(19) United States
(12) Patent Application Publication
(10) Pub. No.: US 2026/0322165 A1
(43) Pub. Date: Oct. 15, 2026

(54) WIRELESS POWER CHARGING SYSTEM USING QUASI-REACTIVE RECTIFICATION

(71) Applicant: Samsung Electronics Co., Ltd., Suwon-si (KR)

(72) Inventor: Hyun Su KIM, Suwon-si (KR)

(21) Appl. No.: 19/405,536

(22) Filed: Dec. 2, 2025

(30) Foreign Application Priority Data
Apr. 15, 2025 (KR) 10-2025-0049126

(51) Int. Cl. H02J 50/10; H02J 50/80

(52) U.S. Cl. CPC H02J 50/10; H02J 50/80

(57) ABSTRACT

A receiver device including a receiver LC tank circuit including a receiver load capacitor and a receiver coil and configured to receive wireless charging power induced from a transmitter device; a rectifier circuit configured to rectify receiver AC voltages of a differential signal provided from the receiver LC tank into a rectified voltage in response to rectifier rectified gate signals; and an overvoltage protection circuit configured to generate and output to the rectifier circuit the rectifier rectified gate signals. The overvoltage protection circuit is configured to generate by the rectifier gate signals so as to cause a shifting of a phase of the differential signal between the receiver AC voltages relative to a receiver coil current in the receiver coil, in response to, the rectified voltage reaching or exceeding to an overvoltage rising threshold.

### CROSS-REFERENCE TO RELATED APPLICATION

This application claims priority from Korean Patent Application No. 10-2025-0049126 filed on Apr. 15, 2025 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a wireless power charging system of an electronic device.

### 2. Description of the Related Art

With the development of information technology (IT), various types of electronic devices such as smartphones and tablet PCs have been widely distributed. It is common for such electronic devices to include a battery module for portability. Wireless charging technology for battery modules has been advancing to improve user convenience, with charging power continuing to increase in order to shorten charging time.

However, as the charging voltage increases to boost charging power, a momentary overvoltage exceeding the withstand voltage of integrated circuits in electronic devices may occur. Therefore, overvoltage protection (OVP) is becoming increasingly important in wireless power charging systems.

### SUMMARY

One objective of the present disclosure is to provide a wireless power charging system with improved voltage clamping efficiency via a quasi-reactive rectification operation.

Another objective of the present disclosure is to provide a wireless power charging system that mitigates unnecessary power loss and potential damage due to coil current during an overvoltage operation, by adjusting the coil current.

The objectives of the present disclosure are not limited to those mentioned above, and other objectives not explicitly stated will be clearly understood by those skilled in the art based on the following description.

According to an aspect of the present disclosure, there is provided a receiver device including a receiver LC tank circuit including a receiver load capacitor and a receiver coil and configured to receive wireless charging power from a transmitter device; a rectifier circuit configured to rectify receiver AC voltages of a differential signal provided from the receiver LC tank into a rectified voltage in response to rectifier gate signals; and an overvoltage protection circuit configured to generate and output to the rectifier circuit the rectifier gate signals. The overvoltage protection circuit is configured to generate the rectifier gate signals so as to cause a shifting of a phase of the differential signal between the receiver AC voltages relative to a receiver coil current in the receiver coil, in response to the rectified voltage reaching or exceeding an overvoltage rising threshold.

One embodiment of the receiver device is further configured that the overvoltage protection circuit is configured to generate the rectifier gate signals to cause the rectifier circuit to perform quasi-reactive rectification and thereby enable voltage clamping of the rectified voltage.

The receiver device is further configured that the rectifier circuit is configured to perform the quasi-reactive rectification in response to receiving the rectifier gate signals to lower the rectified voltage to below the overvoltage rising threshold.

Another embodiment of the receiver device is further configured that the overvoltage protection circuit is further configured, in response to the rectified voltage dropping below an overvoltage falling threshold after voltage clamping has been enabled, to generate the rectifier gate signals to shift the phase of the differential signal between the receiver AC voltages and the receiver coil current so that the phase difference is substantially zero degrees.

According to an aspect of the present disclosure, there is a method of operating a receiver device that wirelessly receives power from a transmitter device, the method including comparing a rectified voltage of the receiver device with an overvoltage rising threshold; generating coil sensing information by sensing a receiver coil current induced from the transmitter device through a receiver coil; obtaining a rising-edge zero points signal indicating rising-edge zero points of the coil sensing information and a falling-edge zero points signal indicating falling-edge zero points of the coil sensing information; shifting the indicated rising-edge zero points and falling-edge zero points in a first direction relative to zero points in the current by applying a first delay to the rising-edge zero points and the falling-edge zero points signals, the first direction corresponding to a phase lag or phase lead; generating rectifier gate signals, for a rectifier circuit, based on the delayed rising-edge zero points and the falling-edge zero points signals; and adjusting the rectified voltage by adjusting a phase difference between a differential signal between receiver AC voltages and a receiver coil current by applying the generated rectifier gate signals to the rectifier circuit.

According to an aspect of the present disclosure, there is a receiver device including a receiver LC tank circuit including a receiver load capacitor and a receiver coil; a coil current sensor configured to generate coil sensing information by sensing a current induced from a transmitter device through the receiver coil; a rectifier circuit including a plurality of switching transistors that are switched in response to rectifier gate signals, and configured to receive receiver AC voltages generated by the receiver LC tank circuit and rectify the receiver AC voltages into a rectified voltage; an overvoltage protection circuit configured to generate the rectifier gate signals based on a comparison between an overvoltage reference level and the rectified voltage and to output the rectifier gate signals to the rectifier circuit; and a main low-dropout (LDO) circuit configured to output a supply voltage with noise removed from the rectified voltage, wherein the rectifier circuit is configured to adjust a phase difference between a differential signal between the receiver AC voltages and a receiver coil current based on the rectifier gate signals received from the overvoltage protection circuit.

The receiver device is further configured that the rectifier circuit configured to perform quasi-reactive rectification in order to adjust the phase between the differential signal between the receiver AC voltages and the receiver coil current based on the rectifier gate signals received from the overvoltage protection circuit.

The receiver device is further configured that the rectifier circuit is configured to perform the quasi-reactive rectification to generate the rectified voltage at a voltage level lower than an overvoltage reference level stored in the receiver device.

The receiver device is further configured that the phase-direction determination circuit is configured to turn-on the first and second pass transistors in response to the first logic level of the polarity test signal and thereby generate the rectified voltage with the first rectified voltage level and turn-off the first and second pass transistors in response to second logic level of the polarity test signal and thereby generate the rectified voltage with the second rectified voltage level.

According to an aspect of the present disclosure, there is a receiver device including a receiver LC tank circuit including a receiver load capacitor and a receiver coil; a coil current sensor configured to generate coil sensing information by sensing a current induced from a transmitter device through the receiver coil; a rectifier circuit including a plurality of switching transistors that are switched in response to rectifier gate signals, and configured to receive receiver AC voltages generated by the receiver LC tank circuit and rectify the receiver AC voltages into a rectified voltage; an overvoltage protection circuit configured to generate the rectifier gate signals based on a comparison between an overvoltage reference level and the rectified voltage and to output the rectifier gate signals to the rectifier circuit; and a main low-dropout (LDO) circuit configured to output a supply voltage with noise removed from the rectified voltage, wherein the rectifier circuit is configured to adjust a phase difference between a differential signal between the receiver AC voltages and a receiver coil current based on the rectifier gate signals received from the overvoltage protection circuit.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a block diagram illustrating a wireless power charging system according to some embodiments of the present disclosure.

FIG. 2 is a block diagram illustrating a receiver MCU in FIG. 1.

FIG. 3 is a block diagram illustrating an overvoltage protection (OVP) circuit in FIG. 1.

FIG. 4 is a timing diagram for explaining the operation of the wireless power charging system of FIG. 1.

FIG. 5 illustrates the wireless power charging system of FIG. 1 as a time-domain wireless power transmission model.

FIG. 6 illustrates a frequency-domain wireless power transmission model corresponding to the wireless power transmission model of FIG. 4.

FIG. 7 is a diagram illustrating a simplified RX-side power transmission model using a resistive rectified impedance in the wireless power transmission model of FIG. 6.

FIG. 8 is a graph for explaining the operation of the RX-side power transmission model of FIG. 7.

FIG. 9 illustrates a simplified RX-side power transmission model using a quasi-reactive rectified impedance in the wireless power transmission model of FIG. 7.

FIG. 10 is a graph for explaining the operation of the RX-side power transmission model of FIG. 9.

FIG. 11 is a phase-voltage graph for explaining the clamping effect on the rectified voltage in a wireless power charging system using quasi-reactive rectification according to some embodiments.

FIG. 12 illustrates an RX-side power transmission model of a comparative example using a clamp resistor.

FIG. 13 is a graph comparing coil current increases against clamped voltage levels between the comparative example of FIG. 12 and the present disclosure.

FIG. 14 is a detailed block diagram of a rectified-gate-signal generator according to some embodiments.

FIG. 15 is a block diagram of a gate signal generator in FIG. 14.

FIG. 16 is a timing diagram for explaining an embodiment of the operation of the wireless power charging system of FIG. 1.

FIG. 17 is a timing diagram for explaining another embodiment of the operation of the wireless power charging system of FIG. 1.

FIG. 18 is a timing diagram for explaining another embodiment of the operation of the wireless power charging system of FIG. 1.

FIG. 19 presents graphs showing a rectified voltage, RX AC voltages, and a coil current according to the operation of a wireless power charging system according to some embodiments, in an overvoltage state.

FIG. 20 is a block diagram illustrating a wireless power charging system according to some embodiments of the present disclosure.

FIG. 21 is a time-voltage graph for explaining how to determine the direction of a phase shift in the wireless power charging system of FIG. 20.

FIG. 22 is a flowchart for explaining an operating method of the wireless power charging system of FIG. 20.

FIG. 23 illustrates an RX-side power transmission model for explaining how to determine the polarity of a reactance component XRX in the wireless power charging system of FIG. 20.

FIG. 24 is a flowchart illustrating an operating method of a wireless power charging system according to some embodiments of the present disclosure.

### DETAILED DESCRIPTION

It will be understood that, although the terms first, second, third etc. may be used herein to describe various elements, and/or components, regions, these elements, and/or components should not be limited by these terms. Unless the context indicates otherwise, these terms are only used to distinguish one element, or component from another element, or component, for example as a naming convention. Thus, a first element, or component discussed below in one section of the specification could be termed a second element, or component in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

Items described in the singular herein may be provided in plural, as can be seen, for example, in the drawings. Thus, the description of a single item that is provided in plural should be understood to be applicable to the remaining plurality of items unless context indicates otherwise.

Throughout the specification, when a component is described as “including” a particular element or group of elements, it is to be understood that the component is formed of only the element or the group of elements, or the element or group of elements may be combined with additional elements to form the component, unless the context indicates otherwise.

It will be understood that when an element is referred to as being “connected” to another element, it can be directly connected or coupled to the other element or intervening elements may be present.

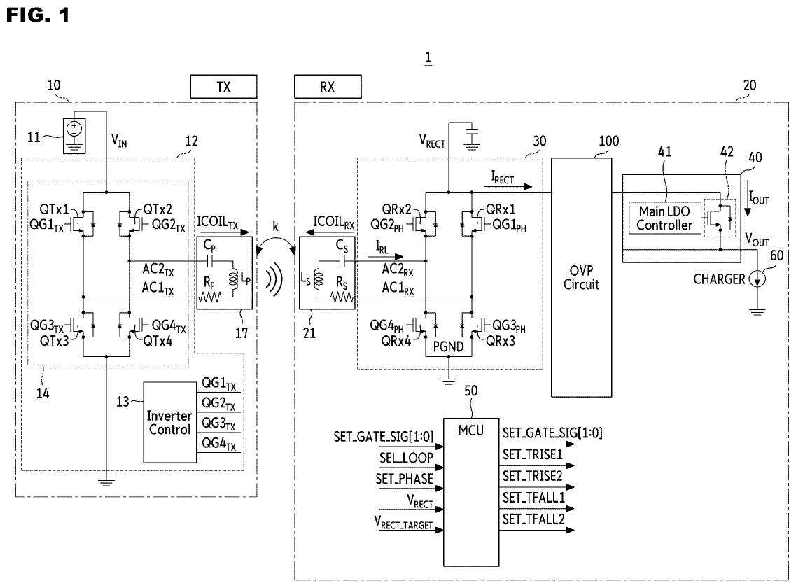

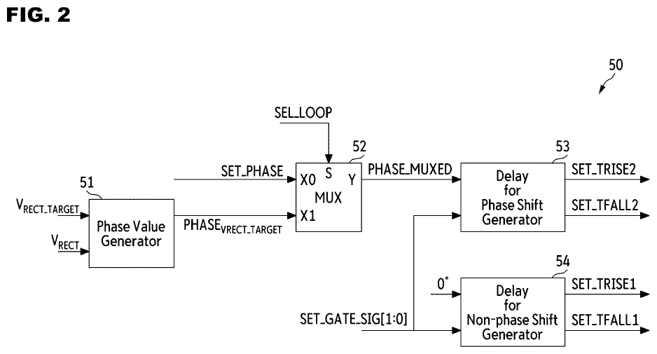

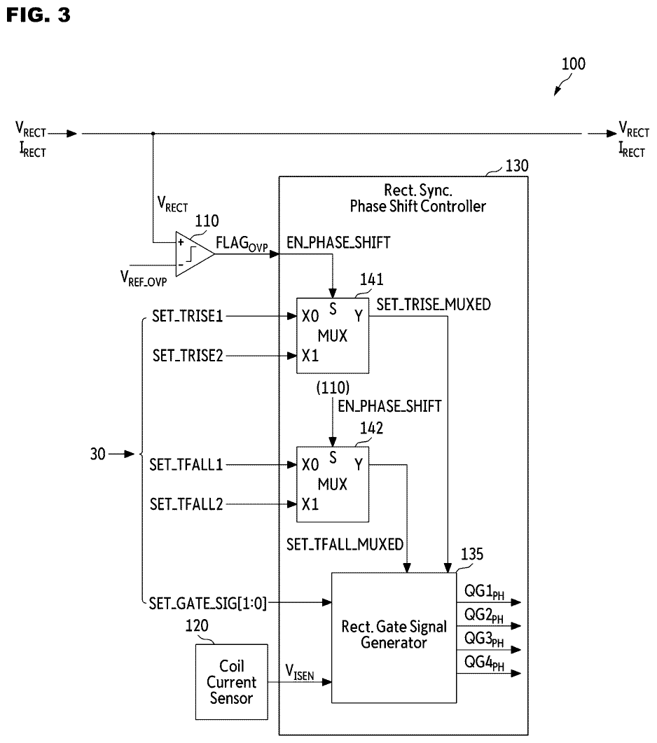

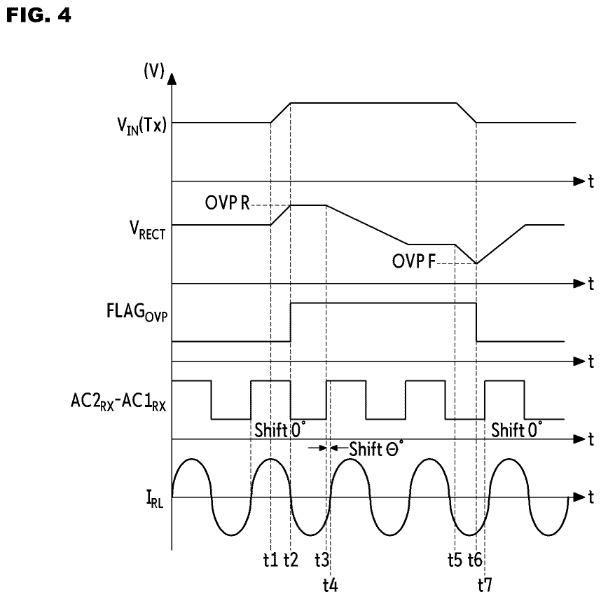

FIG. 1 is a block diagram illustrating a wireless power charging system according to some embodiments of the present disclosure. FIG. 2 is a block diagram illustrating a receiver MCU in FIG. 1. FIG. 3 is a block diagram illustrating an overvoltage protection (OVP) circuit in FIG. 1. FIG. 4 is a timing diagram for explaining the operation of the wireless power charging system of FIG. 1.

Referring to FIGS. 1 and 2, a transmitter (TX) device 10 includes an input power supply 11, an inverter 12, and a TX LC tank 17 circuit (also referred to as LC circuit).

The input power supply 11 supplies input power V_{IN} to be transmitted from the TX device 10 to a receiver (RX) device 20. The inverter 12 includes an inverter controller 13 and a TX bridge circuit 14. The inverter controller 13 generates first, second, third, and fourth TX rectifier gate signals QG1_{TX}, QG2_{TX}, QG3_{TX}, and QG4_{TX}. The TX bridge circuit 14 is connected between the input power supply 11 and a ground terminal and includes four switching transistors QTx1, QTx2, QTx3, and QTx4 that are respectively turned on/off by the first, second, third, and fourth TX rectifier gate signals QG1_{TX}, QG2_{TX}, QG3_{TX}, and QG4_{TX}, and generates at its output a TX coil current ICOIL_{TX}.

The TX bridge circuit 14 generates a first TX alternating current (AC) voltage AC1_{TX} and a second TX AC voltage AC2_{TX} between opposite ends of the bridge by complementarily switching the four switching transistors according to the first, second, third, and fourth TX rectifier gate signals QG1_{TX}, QG2_{TX}, QG3_{TX}, and QG4_{TX}. The complementarily switched first and second TX AC voltages AC1_{TX} and AC2_{TX} are supplied to the TX LC tank circuit 17 as AC power or AC power signal, thereby transmitting wireless charging power to the RX device 20. The TX LC tank circuit 17 includes a TX load capacitor C_{P} and a TX coil, which is represented by a TX inductor L_{P} and a TX parasitic resistor R_{P}.

The RX device 20 includes an RX LC tank 21, a rectifier circuit 30, a main low-dropout (LDO) regulator circuit 40, an RX microcontroller unit (MCU) 50 (also referred to as a microcontroller), a battery 60, and an overvoltage protection (OVP) circuit 100. An MCU may be a logic circuit that forms a controller (e.g., hardware processor (e.g., CPU)) for the device (in this instance, for the RX device 20).

The RX LC tank 21 receives wireless charging power from the TX device 10. The RX LC tank 21 includes an RX load capacitor C_{S} and an RX coil, which is represented by an RX inductor L_{S} and an RX parasitic resistor R_{S}.

The rectifier circuit 30 generates a rectified voltage V_{RECT} based on a first RX AC voltage AC1_{RX} and a second RX AC voltage AC2_{RX}, which are generated by the RX LC tank circuit 21, and an RX coil current I_{RL}, which is generated by the RX LC tank circuit 21. In some embodiments, the rectifier circuit 30 includes a plurality of RX switching transistors connected in a bridge form that receive the first and second RX AC voltages AC1_{RX} and AC2_{RX} as input, and the plurality of RX switching transistors QRx1, QRx2, QRx3, and QRx4 are complementarily switched by the first, second, third, and fourth rectifier gate signals QG1_{PH}, QG2_{PH}, QG3_{PH}, and QG4_{PH}, thereby generating the rectified voltage V_{RECT} and a rectified current I_{RECT}. The plurality of RX switching transistors (QRx1-QRx4) included in the rectifier circuit 30 may be connected in the same configuration as the TX bridge circuit 14.

For example, the rectifier circuit 30 includes a first electrical/current path that includes a first RX switching transistor QRx1 and a third RX switching transistor QRx3 connected in series, and a second path that includes a second RX switching transistor QRx2 and a fourth RX switching transistor QRx4 connected in series. The paths referenced herein will be understood to refer to current or electrical paths unless context indicates otherwise. The first and second paths are connected in parallel between an output node and a ground node. A common node of the first and third RX switching transistors (QRx1 and QRx3) in the first path receives the first AC voltage AC1_{RX}, and a common node of the second and fourth RX switching transistors (QRx2 and QRx4) in the second path receives the second AC voltage AC2_{RX}. The first, second, third, and fourth RX switching transistors (QRx1-QRx4) are respectively switched by first, second, third, and fourth rectifier gate signals QG1_{PH}, QG2_{PH}, QG3_{PH}, and QG4_{PH}, respectively. For example, the first and fourth RX switching transistors (QRx1 and QRx4) are complementarily switched with the second and third RX switching transistors (QRx2 and QRx3).

The main LDO circuit 40 removes noise from the rectified voltage V_{RECT} and stably supplies a noise-removed supply voltage V_{OUT} to the battery 60. The main LDO circuit 40 includes an LDO controller 41 and an LDO pass transistor 42. The LDO controller 41 adjusts the supply voltage VOUT so as to minimize dropout voltage by providing a gate signal to the LDO pass transistor 42 based on a reference voltage and feedback. The LDO pass transistor 42 outputs the noise-removed supply voltage V_{OUT} from the rectified voltage V_{RECT} to the battery 60.

The RX MCU 50 generates various control signals based on setting signals (SEL_LOOP, SET_PHASE, VRECT_TARGET, and SET_GATE_SIG[1:0]) and the rectified voltage V_{RECT} received from the rectifier circuit 30. For example, the RX MCU 50 provides a gate-signal control signal SET_GATE_SIG[1:0], first-type time delay information (SET_TRISE1 and SET_TFALL1), and second-type time delay information (SET_TRISE2 and SET_TFALL2) to the OVP circuit 100. Note that “timing/time delay information” may refer to the information itself (e.g., data, a value or setting representing a delay) and/or to a signal that includes or conveys such information, depending on context.

Referring to FIG. 2, the RX MCU 50 may be implemented to include or function as a phase value generator 51, a setting value selector 52, a first phase shift delay value generator 53, and a second phase shift delay value generator 54.

In some embodiments, the RX MCU 50 may receive the setting signals output from a firmware based on the state of the RX device 20 or user settings. The setting signals from the firmware may include, for example, a delay value selection signal SEL_LOOP, a phase setting value SET_PHASE, a target rectified voltage V_{RECT_TARGET}, and the gate-signal control signal SET_GATE_SIG[1:0].

The phase value generator 51 compares the rectified voltage V_{RECT} with the target rectified voltage V_{RECT_TARGET}, calculates a phase value to bring the rectified voltage V_{RECT} to the target rectified voltage V_{RECT_TARGET}, and outputs the calculated phase value as a target phase shift value PHASE_{VRECT_TARGET}.

The setting value selector 52 selects either the phase setting value SET_PHASE or the target phase shift value PHASE_{VRECT_TARGET} based on the delay value selection signal SEL_LOOP and outputs the selected value as a phase selection value PHASE_MUXED.

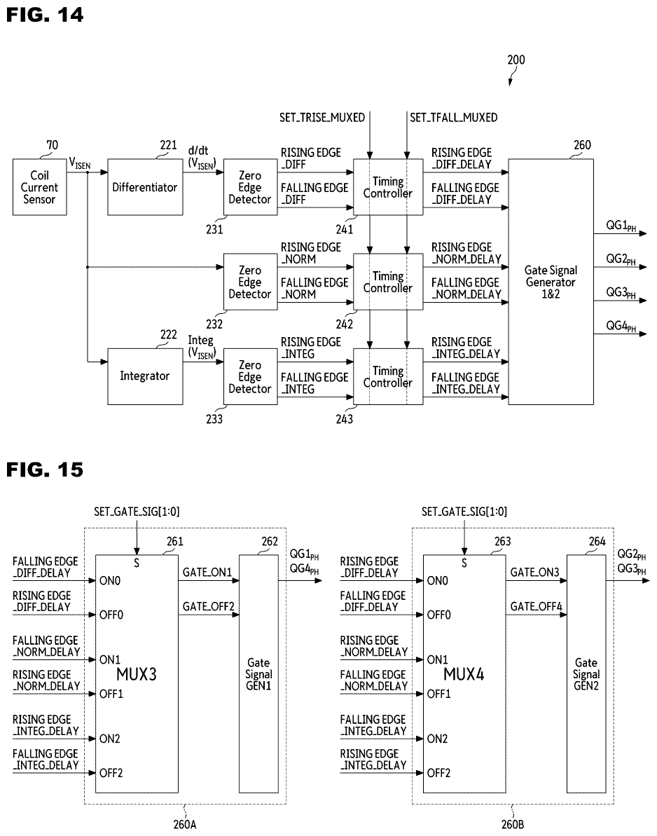

The first phase shift delay value generator 53 adjusts the phase selection value PHASE_MUXED according to the gate-signal control signal SET_GATE_SIG[1:0] and outputs the adjusted value as second-type time delay information (SET_TRISE2 and SET_TFALL2) to an OVP circuit 100. The gate-signal control signal SET_GATE_SIG[1:0] is a signal that selects a first path through a differentiator circuit 221, a second path with no differentiator or integrator, or a third path through an integrator circuit 222, examples of which are depicted in FIG. 14.

For example, if the gate-signal control signal SET_GATE_SIG[1:0] selects the first path, the first phase shift delay value generator 53 adjusts the phase selection value PHASE_MUXED using the differentiator 221, thereby generating and outputting first second-type time delay information (SET_TRISE2a and SET_TFALL2a). For example, if the gate-signal control signal SET_GATE_SIG[1:0] selects the second path, the first phase shift delay value generator 53 adjusts the phase selection value PHASE_MUXED, thereby generating and outputting second second-type time delay information signals (SET_TRISE2b and SET_TFALL2b). For example, if the gate-signal control signal SET_GATE_SIG[1:0] selects the third path, the first phase shift delay value generator 53 adjusts the phase selection value PHASE_MUXED using the integrator 222, thereby generating and outputting third second-type time delay information signals (SET_TRISE2c and SET_TFALL2c).

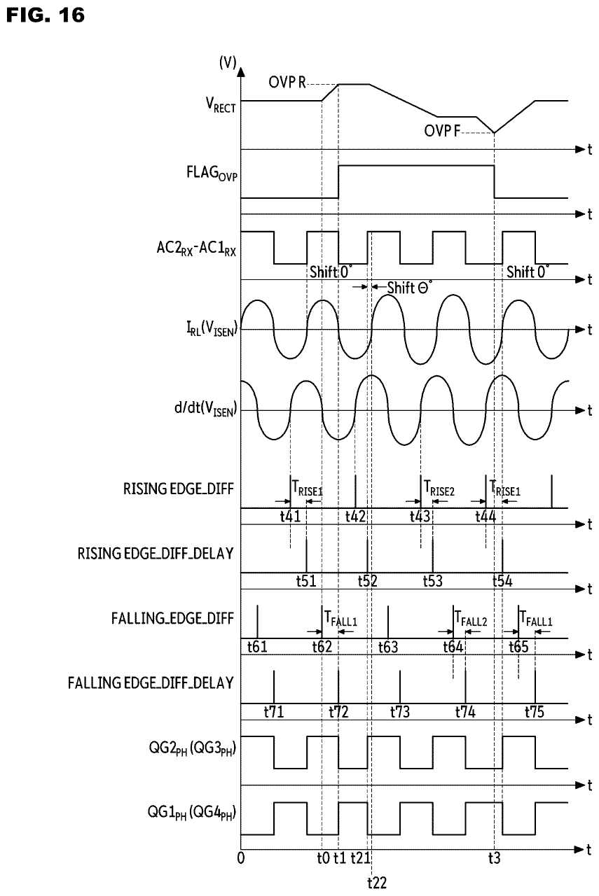

The first second-type time delay information signals (SET_TRISE2a and SET_TFALL2a), the second second-type time delay information signals (SET_TRISE2b and SET_TFALL2b), and the third second-type time delay information signals (SET_TRISE2c and SET_TFALL2c) may have different values, as depicted in FIGS. 16 through 18.

The second phase shift delay value generator 54 outputs first-type time delay information signals (SET_TRISE1 and SET_TFALL1) to the OVP circuit 100 according to the gate-signal control signal SET_GATE_SIG[1:0].

For example, if the gate-signal control signal SET_GATE_SIG[1:0] selects the first path, the second phase shift delay value generator 54 generates and outputs first first-type time delay information (SET_TRISE1a and SET_TFALL1a). If the gate-signal control signal SET_GATE_SIG[1:0] selects the second path, the second phase shift delay value generator 54 generates and outputs, through adjustment, second first-type time delay information (SET_TRISE1b and SET_TFALL1b). If the gate-signal control signal SET_GATE_SIG[1:0] selects the third path, the second phase shift delay value generator 54 generates and outputs third first-type time delay information (SET_TRISE1c and SET_TFALL1c).

The first first-type time delay information (SET_TRISE1a and SET_TFALL1a), the second first-type time delay information (SET_TRISE1b and SET_TFALL1b), and the third first-type time delay information (SET_TRISE1c and SET_TFALL1c) may have different values, as depicted in FIGS. 16 through 18.

In some embodiments, the RX MCU 50 may output the second-type time delay information (SET_TRISE2 and SET_TFALL2) as a first setting value based on a phase setting value SET_PHASE output according to the delay value selection signal SEL_LOOP, such that a phase shift of θ° is performed, allowing a rectified-gate-signal generator 135 to generate the first, second, third, and fourth rectifier gate signals QG1_{PH}, QG2_{PH}, QG3_{PH}, and QG4_{PH} corresponding to the first setting value. In this case, the phase shift of non-zero θ° may result in a change in resonance characteristics due to an active reactance change caused by a phase lag or phase lead operation, thereby enabling a quasi-reactive rectification operation between the RX device 20 and the TX device 10.

In some embodiments, the RX MCU 50 may output time delay information (SET_TRISE2 and SET_TFALL2) as a second setting value based on a target phase shift value PHASE_{VRECT_TARGET} output according to the delay value selection signal SEL_LOOP, such that the rectified voltage V_{RECT} gradually or continuously changes to becomes the target rectified voltage V_{RECT_TARGET}, allowing the rectified-gate-signal generator 135 to generate phase-shifted first, second, third, and fourth rectifier gate signals QG1_{PH}, QG2_{PH}, QG3_{PH}, and QG4_{PH} corresponding to the second setting value. In this case, unlike the first setting value, the second setting value may gradually or continuously change until the rectified voltage V_{RECT} approaches the target rectified voltage V_{RECT_TARGET}.

Referring to FIG. 3, the OVP circuit 100 includes a comparator 110, a coil current sensor 120, and a rectified power synchronization phase-shift controller 130.

The comparator 110 compares the rectified voltage V_{RECT} generated by the rectifier circuit 30 with a preset overvoltage reference level V_{REF_OVP}, and generates an overvoltage flag signal FLAG_{OVP} as a phase-shift control signal EN_PHASE_SHIFT based on the comparison result. The overvoltage reference level V_{REF_OVP} may be a value set by the RX MCU 50 or a value set by firmware. For example, the overvoltage reference level and other thresholds described herein may programmed or stored (e.g., stored on non-volatile storage or registers) of the receiver device 20.

The rectified power synchronization phase-shift controller 130 includes a rectified-gate-signal generator 135, a first multiplexer 141, and a second multiplexer 142.

The first and second multiplexers 141 and 142 select one of a plurality of pieces of timing delay information (SET_TRISE1, SET_TRISE2, SET_TFALL1, and SET_FALL2) based on the phase-shift control signal EN_PHASE_SHIFT and provide the selected timing delay information to the rectified-gate-signal generator 135.

For example, when the phase-shift control signal EN_PHASE_SHIFT is deactivated, the first multiplexer 141 selects and outputs first rising time delay information SET_TRISE1 as selected rising time delay information SET_TRISE_MUXED. For example, when the phase-shift control signal EN_PHASE_SHIFT is activated, the first multiplexer 141 selects and outputs second rising time delay information SET_TRISE2 as the selected rising time delay information SET_TRISE_MUXED.

For example, when the phase-shift control signal EN_PHASE_SHIFT is deactivated, the second multiplexer 142 selects and outputs first falling time delay information SET_TFALL1 as selected falling time delay information SET_TFALL_MUXED. For example, when the phase-shift control signal EN_PHASE_SHIFT is activated, the second multiplexer 142 selects and outputs second falling time delay information SET_TFALL2 as the selected falling time delay information SET_TFALL_MUXED.

When the phase-shift control signal EN_PHASE_SHIFT is deactivated (0), the rectified-gate-signal generator 135 generates the first, second, third, and fourth rectifier gate signals QG1_{PH}, QG2_{PH}, QG3_{PH}, and QG4_{PH} such that a differential signal (AC2_{RX}−AC1_{RX}) between the first and second RX AC voltages AC1_{RX} and AC2_{RX} has the same phase as the RX coil current I_{RL}, based on the selected rising time delay information SET_TRISE_MUXED and selected falling time delay information SET_TFALL_MUXED.

When the phase-shift control signal EN_PHASE_SHIFT is activated (1), the rectified-gate-signal generator 135 performs phase shift according to the selected rising time delay information SET_TRISE_MUXED and selected falling time delay information SET_TFALL_MUXED, and generates and outputs first, second, third, and fourth rectifier gate signals QG1_{PH}, QG2_{PH}, QG3_{PH}, and QG4_{PH} that are shifted in phase by θ° (i.e., not 0°).

In this specification, a phase shift may be classified as a phase lag or a phase lead depending on its direction. For example, referring to FIG. 4, a phase shift that shifts the differential signal (AC2_{RX}−AC1_{RX}) backward by θ° relative to the RX coil current I_{RL} is referred to as a phase lead, and a phase shift that shifts the differential signal (AC2_{RX}−AC1_{RX}) forward by θ° relative to the RX coil current I_{RL} is referred to as a phase lead.

For example, when the overvoltage flag signal FLAG_{OVP} is deactivated (0), the rectified-gate-signal generator 135 generates and outputs the first, second, third, and fourth rectifier gate signals QG1_{PH}, QG2_{PH}, QG3_{PH}, and QG4_{PH} such that the phase of the differential signal (AC2_{RX}−AC1_{RX}) becomes the same as that of the RX coil current I_{RL}, based on the selected rising time delay information SET_TRISE_MUXED and selected falling time delay information SET_TFALL_MUXED in response to a deactivated phase-shift control signal EN_PHASE_SHIFT. Conversely, when the overvoltage flag signal FLAG_{OVP} is activated (1), the rectified-gate-signal generator 135 generates and outputs first, second, third, and fourth rectifier gate signals QG1_{PH}, QG2_{PH}, QG3_{PH}, and QG4_{P}H such that the differential signal (AC2_{RX}−AC1_{RX}) lags in phase by θ° relative to the RX coil current I_{RL}, based on the selected rising and falling time delay information SET_TRISE_MUXED and SET_TFALL_MUXED selected under the activated EN_PHASE_SHIFT signal.

Referring to FIGS. 3 and 4, the rectified power synchronization phase-shift controller 130 compares the rectified voltage V_{RECT} with a preset overvoltage rising threshold OVP R, thereby generating the overvoltage flag signal FLAG_{OVP}. The overvoltage flag signal FLAG_{OVP} is input into the rectified power synchronization phase-shift controller 130 as the phase-shift control signal EN_PHASE_SHIFT.

In the period from 0 to t1, when the rectified voltage V_{RECT} is lower than the overvoltage rising threshold OVP R and the overvoltage flag signal FLAG_{OVP} is deactivated (FLAG_{OVP}=Low), the rectified power synchronization phase-shift controller 130 generates a differential signal (AC2_{RX}−AC1_{RX}) having the same phase as the RX coil current I_{RL} (i.e., a phase shift of 0°).

At t1, as the level of an input voltage V_{IN}(TX) in the TX device 10 rises, the rectified voltage V_{RECT} increases, and at t2, when the rectified voltage V_{RECT} reaches the preset overvoltage rising threshold OVP R, the rectified power synchronization phase-shift controller 130 activates the overvoltage flag signal FLAG_{OVP} (FLAG_{OVP}=High).

When the overvoltage flag signal FLAG_{OVP} is activated, the rectified power synchronization phase-shift controller 130 generates the first, second, third, and fourth rectifier gate signals QG1_{PH}, QG2_{PH}, QG3_{PH}, and QG4_{PH} such that the differential signal (AC2_{RX}−AC1_{RX}) has a phase different from that of the RX coil current I_{RL} by θ° (i.e., a phase shift of θ°).

When the rectified voltage V_{RECT} drops to a preset overvoltage falling threshold OVP F after voltage clamping, the rectified power synchronization phase-shift controller 130 deactivates the overvoltage flag signal FLAG_{OVP} (FLAG_{OVP}=Low). When the overvoltage flag signal FLAG_{OVP} is deactivated (e.g., at t7), the rectified power synchronization phase-shift controller 130 generates a differential signal (AC2_{RX}−AC1_{RX}) having the same phase as the RX coil current I_{RL} (i.e., a phase shift of 0°).

In some embodiments, the overvoltage rising and falling thresholds OVP R and OVP F are output from the RX MCU 50 and provided to the comparator 110 (e.g., provided as V_{REF_OVP}). The comparator 110 outputs the result of the comparison between the rectified voltage V_{RECT} and the overvoltage rising and falling thresholds OVP R and OVP F as the overvoltage flag signal FLAG_{OVP}.

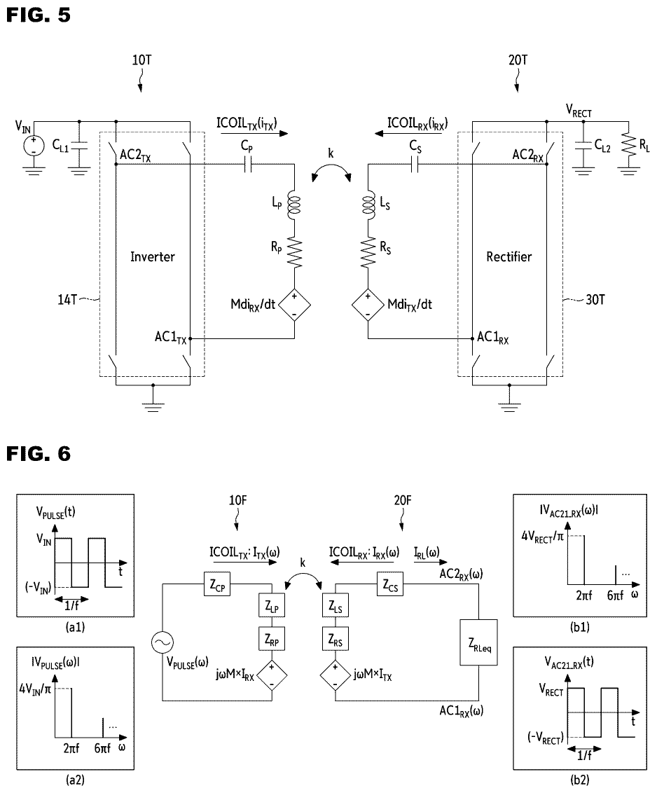

FIG. 5 illustrates the wireless power charging system of FIG. 1 as a time-domain wireless power transmission model. FIG. 6 illustrates a frequency-domain wireless power transmission model corresponding to the wireless power transmission model of FIG. 4. For a theoretical explanation of the operation of the wireless power charging system of FIG. 1, the wireless power charging system of FIG. 1 will hereinafter be described as a power transmission model with mutual components expressed in both time and frequency domains.

Referring to FIGS. 5 and 6, a TX coil of a TX device 10T and an RX coil of an RX device 20T are coupled with a coupling factor k. The TX device 10T includes a TX bridge circuit 14T, which operates as an inverter for converting an input voltage V_{IN} into first and second TX AC voltages AC1_{TX} and AC2_{TX}, and the RX device 20T includes a rectifier circuit 30T, which generates a rectified voltage V_{RECT} from first and second RX AC voltages AC1_{RX} and AC2_{RX} induced in the RX coil. In the TX device 10T, there appears mutual power Mdi_{RX}/dt related to the RX coil current ICOIL_{RX}, and in the RX device 20F, there appears mutual power Mdi_{TX}/dt related to the TX coil current ICOIL_{TX}.

In FIG. 5, C_{P} denotes the capacitance of the TX capacitor, L_{P} denotes the inductance of the TX inductor, R_{P} denotes the parasitic resistance of the TX LC tank circuit 17, C_{S} denotes the capacitance of the RX capacitor, L_{S} denotes the inductance of the RX inductor, and R_{S} denotes the parasitic resistance of the RX LC tank circuit 21.

Additionally, AC1_{TX} and AC2_{TX} represent first and second TX AC voltages, respectively, generated by the TX bridge circuit 14T, and V_{IN} represents an input voltage of the TX device 10T. Furthermore, AC1_{RX} and AC2_{RX} indicate first and second RX AC voltages, respectively, input to the rectifier circuit 30T of the RX device 20T, and V_{RECT} denotes the rectified voltage generated and output by the rectifier circuit 30T. Also, R_{L} represents a load resistor.

Analysis of the wireless power charging system in the time domain is highly difficult because it involves analyzing current, voltage, and power based on capacitors, inductors, and resistors using higher-order differential equations through differentiation/integration. Therefore, the wireless power charging system in the time domain is converted to the frequency domain. The wireless power charging system in the frequency domain may be analyzed using only first-order equations, in accordance with Ohm's law, while still representing the respective impedances.

The wireless power charging transmission model of FIG. 6 is obtained by transforming the time-domain wireless power charging transmission model of FIG. 5 into the frequency domain using Fourier transform.

The capacitors, inductors, and resistors in FIG. 5 may be represented as impedance components (e.g., Z_{CP}, Z_{LP}, Z_{RP}, Z_{CS}, Z_{LS}, Z_{RS}, Z_{CM}, and Z_{RLeq}) in the frequency domain. Each impedance component may be calculated by Equations 1, 2, and 3.

$${Z}_{CP} = \frac{1}{j ω {C}_{P}} , {Z}_{LP} = j ω {L}_{P} , {Z}_{RP} = {R}_{P} , {Z}_{CS} = \frac{1}{j ω {C}_{S}} \qquad [ Equation 1 ]$$

$${Z}_{LS} = j ω {L}_{S} , {Z}_{RS} = {R}_{S} , {Z}_{CM} = \frac{1}{j ω {C}_{M}} \qquad [ Equation 2 ]$$

$$M = k \sqrt{{L}_{P} {L}_{S}} \qquad [ Equation 3 ]$$

M in FIGS. 5 and 6 is mutual inductance. As the inductances L_{P} and L_{S} of the TX and RX coils are coupled, the mutual inductance M is as defined by Equation 3 above.

An RX-side load resistance R_{L} in FIG. 6 is transformed from the frequency domain into an equivalent rectified impedance Z_{RLeq} caused by the load resistance R_{L}, as expressed by Equation 4.

$${Z}_{RLeq} = {A}_{RL} ( \frac{8}{{π}^{2}} ) \times {R}_{L} \qquad [ Equation 4 ]$$

Here, assuming an ideal rectifier operation, A_{RL} is 1, and may vary otherwise.

Since a TX device 10F and an RX device 20F are coupled, the power on each side changes according to the induced current on the opposite side, making it difficult to calculate an operating point. For example, the TX-side mutual power Mdi_{RX}/dt in FIG. 5 is transformed into jωM×I_{RX} in the frequency domain, and the RX-side mutual power Mdi_{TX}/dt in FIG. 5 is converted into jωM×I_{TX} in the frequency domain. To calculate the operating point of the wireless power charging transmission model, a TX coil current I_{TX} is derived based on the RX device 20F, as indicated by Equation 5.

$${I}_{TX} = \frac{{V}_{PULSE} ( ω ) - {jwMI}_{RX}}{{Z}_{CP} + {Z}_{LP} + {Z}_{RP}} \qquad [ Equation 5 ]$$

Then, by substituting the TX coil current I_{TX} of Equation 5 into the mutual power of the RX device 20F, i.e., jωM×I_{TX}, a simplified RX-side power transmission model may be obtained as shown in Equation 6, where all the TX-side components are eliminated, leaving only the RX-side elements.

$$j ω M \times {I}_{TX} = j ω M \times \frac{{V}_{PULSE} ( ω ) - {jwMI}_{RX}}{{Z}_{CP} + {Z}_{LP} + {Z}_{RP}} = \frac{j ω {MV}_{PULSE} ( ω )}{{Z}_{P}} - \frac{{( j ω M )}^{2} {I}_{RX}}{{Z}_{P}} \qquad [ Equation 6 ]$$

Referring to (a1) of FIG. 6, a transmission voltage V_{PULSE}(t) of the TX device 10F may be in the form of a square pulse having a period of 1/f. A transmission voltage V_{PULSE}(ω) in the frequency domain may be represented as a short pulse appearing at frequencies ω of 2πf and 6πf, as shown in (a2) of FIG. 6.

Similarly, in the RX device 20F, an RX AC voltage V_{AC21_RX}(ω) may be represented in the form of a short pulse appearing at the frequencies ω of 2πf and 6πf, as shown in (b1) of FIG. 6. When the RX AC voltage V_{AC21_RX}(ω) is converted to the time domain, a resulting RX AC voltage V_{AC21_RX}(t) may be represented as a square pulse having a period of 1/f and an amplitude equal to the rectified voltage V_{RECT}, as shown in (b2) of FIG. 6.

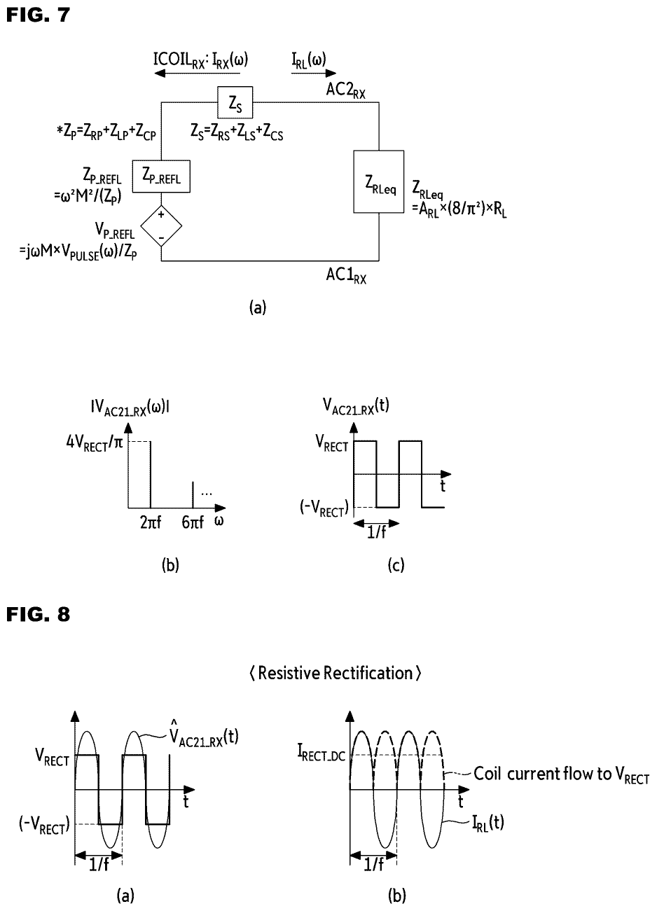

FIG. 7 is a diagram illustrating a simplified RX-side power transmission model using a resistive rectified impedance in the wireless power transmission model of FIG. 6. FIG. 8 is a graph for explaining the operation of the RX-side power transmission model of FIG. 7.

The simplified model illustrated in FIG. 7 is a circuit transformed into a unidirectional circuit (e.g., from the perspective of an RX device) from a bidirectional circuit in which the TX device 10F and the RX device 20F mutually affect each other, in order to calculate an operating point. For convenience, in this simplified RX-side power transmission model, jωM×I_{TX}, which represents the mutual influence of the TX device 10F in Equation 6, is described by replacing the TX-side components with RX-side components.

Specifically, as shown in (a) of FIG. 7, jωM×I_{TX} is expressed with reflected power V_{P_REFL} and a reflected impedance Z_{P_REFL} by reflecting RX-side components. Here, the load resistance R_{L} at the rear end of the rectifier circuit 30T of FIG. 5 is expressed as a rectified impedance Z_{RLeq} between first and second RX AC nodes, as shown in FIGS. 6 and 7(a) and Equation 7.

$${Z}_{R L e q} = {A}_{R L} ( \frac{8}{{π}^{2}} ) \times {R}_{L} \qquad [ Equation 7 ]$$

An RX AC voltage V_{AC21_RX}(ω) applied across the rectified impedance Z_{RLeq} may be represented as shown in (b) of FIG. 7, similar to (b1) of FIG. 6, and may be expressed as a square pulse in the time domain, as shown in (c) of FIG. 7, similar to (b2) of FIG. 6.

The rectified impedance Z_{RLeq} between the first and second RX AC nodes may be obtained by dividing a voltage V_{AC21_RX} between the first and second RX AC nodes of the RX LC tank circuit 21 by the RX coil current I_{RL}, as indicated by Equation 8.

V_{AC21_RX}=AC2_{RX}−AC1_{RX}

Z_{RLeq}=V_{AC21_RX}/I_{RL} [Equation 8]

Referring to (a) FIG. 8, assuming an ideal rectifier operation, the voltage V_{AC21__RX} between the first and second RX AC nodes of the RX LC tank circuit 21 may be considered a square wave toggling between the rectified voltage V_{RECT} and an inverted rectified voltage −V_{RECT} at a period of 1/f Since this toggling operation is based on the zero points of the RX coil current I_{RL}, the phase difference between the RX coil current I_{RL} and a voltage \hat{V}_{AC21_RX} between the first and second RX AC nodes of the RX LC tank circuit 21 converges to approximately 0°.

Therefore, under ideal conditions, the rectified impedance Z_{RLeq} may be viewed as resistive rectified impedance. Referring to (b) of FIG. 7, the voltage V_{AC21_RX} between the first and second RX AC nodes of the RX LC tank circuit 21 may be approximated by extracting only the single-tone operating frequency component, as indicated by Equation 8.

$${V}_{AC 21 \_ RX} ≅ {\hat{V}}_{AC 21\_ RX} = ( \frac{4}{π} ) {V}_{R E C T} \times sin ( ω t ) \qquad [ Equation 9 ]$$

The RX coil current I_{RL}, as the coil sensing information (e.g., V_{ISEN} and I_{ISEN}), generally appears as a sine wave, but its amplitude is unknown. An amplitude I_{M} of the RX coil current I_{RL} may be derived by Equation 10.

$$( \frac{1}{π} ) {\int }_{0}^{π} {I}_{R L} d ω t = ( \frac{1}{π} ) {\int }_{0}^{π} {I}_{M} sin ( ωt ) d ω t = {I}_{RECT \_ DC} \qquad [ Equation 10 ]$$

$${I}_{M} = ( \frac{π}{2} ) {I}_{RECT \_ DC}$$

The resistive rectified impedance Z_{RLeq} shown in FIG. 7(a) may be calculated from Equations 9 and 10, as indicated by Equation 11.

$${Z}_{R L e q} = \frac{{V}_{AC 21\_ RX} ( ω )}{{I}_{R L} ( ω )} ≅ \frac{( \frac{4}{π} ) {V}_{R E C T}}{( \frac{π}{2} ) {I}_{RECT \_ DC}} = ( \frac{8}{{π}^{2}} ) {R}_{L} \qquad [ Equation 11 ]$$

In a resistive rectification method, the rectified voltage V_{RECT} may be obtained based on the reflected power V_{P_REFL} and the voltage dividing ratio of each impedance in the circuit model, as shown in Equation 12.

$$[ Equation 12 ]$$

$${V}_{RECT} ≅ \frac{π}{4} {V}_{P \_ REFL} ( \frac{{Z}_{R L e q}}{{Z}_{P \_ REFL} + {Z}_{S} + {Z}_{R L e q}} ) = \frac{π}{4} {V}_{P \_ REFL} ( \frac{{A}_{R L} ( \frac{8}{{π}^{2}} ) {R}_{L}}{{R}_{R X} + {jX}_{R X} + {A}_{R L} ( \frac{8}{{π}^{2}} ) {R}_{L}} )$$

The RX coil current I_{RL} may be obtained by dividing the reflected power V_{P_REFL} by the sum of the total impedance, as shown in Equation 13.

$${I}_{R L} = \frac{π}{4} {V}_{P \_ REFL} ( \frac{1}{{R}_{R X} + {jX}_{R X} + {A}_{R L} ( \frac{8}{{π}^{2}} ) {R}_{L}} ) \qquad [ Equation 13 ]$$

Further, in the resistive rectification method, the magnitudes of the rectified voltage V_{RECT} and the RX coil current I_{RL}, i.e., |V_{RECT}| and |I_{RL}|, may be obtained as shown in Equations 14 and 15, respectively.

$$[ Equation 14 ]$$

$$\vert {V}_{RECT} \vert ≅ \frac{π}{4} {V}_{P \_ REFL} ( \frac{{A}_{R L} ( \frac{8}{{π}^{2}} ) {R}_{L}}{\sqrt{{( {R}_{R X} + {A}_{R L} ( \frac{8}{{π}^{2}} ) {R}_{L} )}^{2} + {( {X}_{R X} )}^{2}}} )$$

$$[ Equation 15 ]$$

$$\vert {I}_{R L} \vert = \frac{π}{4} {V}_{P \_ REFL} ( \frac{1}{\sqrt{{( {R}_{R X} + {A}_{R L} ( \frac{8}{{π}^{2}} ) {R}_{L} )}^{2} + {( {X}_{R X} )}^{2}}} )$$

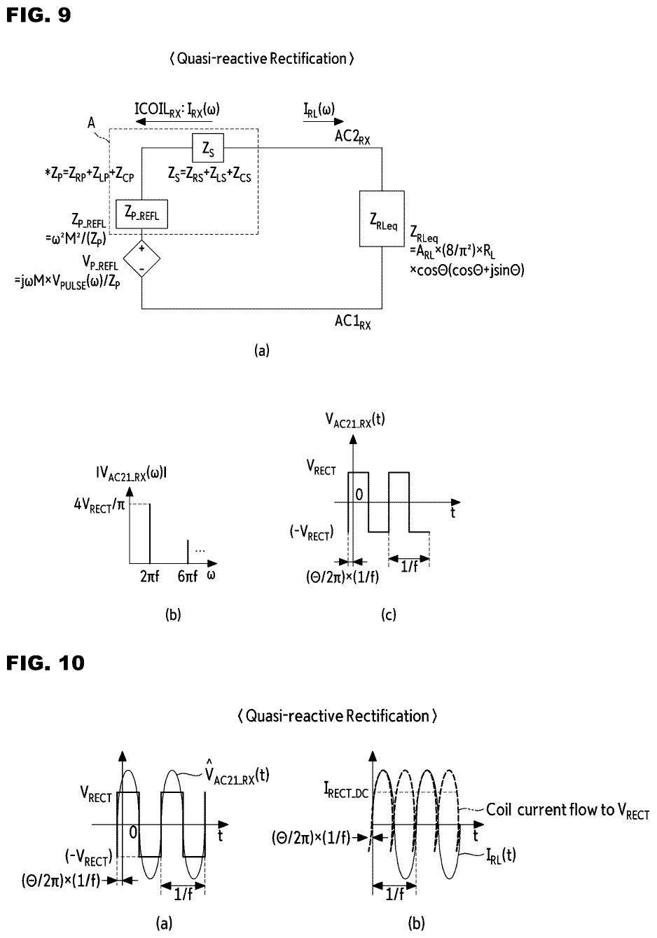

(a) of FIG. 9 illustrates a simplified RX-side power transmission model using a quasi-reactive rectified impedance in the wireless power transmission model of (a) of FIG. 7. FIG. 10 includes at (a) and (b) graphs for explaining the operation of the RX-side power transmission model of (a) of FIG. 9.

Referring to (a)-(c) of FIG. 9 and (a) and (b) of FIG. 10, in the simplified unidirectional RX-side power transmission model, jωM×I_{TX}, which represents the mutual influence of the TX device 10F in Equation 6, is reflected with RX-side components, as mentioned earlier with reference to (a) of FIG. 8, and expressed using reflected power V_{P_REFL} and a reflected impedance Z_{P_REFL}. In a quasi-reactive rectification operation, the phase of the voltage V_{AC21_RX} between the first and second RX AC nodes is shifted by θ relative to the phase of the RX coil current I_{RL}.

Since the reflected impedance Z_{P_REFL} and an impedance Zs of the RX coil are connected in series, as denoted by “A” in (a) of FIG. 9, they may be represented as a combined impedance Z_{RX}. The combined impedance Z_{RX} may be expressed as a resistance component R_{RX} related to power consumption and an inductive reactance component X_{RX}, as shown in Equation 16.

Z_{P}_{_{REFL}}+Z_{S}=Z_{RX}=R_{RX}+jX_{RX} [Equation 16]

The voltage V_{AC21_RX} between the first and second RX AC nodes of the RX LC tank circuit 21 operates by being shifted in phase by θ relative to the RX coil current I_{RL}. To this end, the phase of the voltage V_{AC21_RX} may be shifted by θ with respect to the RX coil current I_{RL}, as shown in (a) and (b) of FIG. 10, compared to the resistive impedance of (a) of FIG. 7. In this case, the voltage V_{AC21_RX} between the first and second RX AC nodes is expressed as shown in Equation 17.

$${V}_{AC 21\_ RX} ≅ {\hat{V}}_{AC 21\_ RX} = ( \frac{4}{π} ) {V}_{R E C T} \times sin ( ω t + θ ) \qquad [ Equation 17 ]$$

When the voltage V_{AC21_RX} between the first and second RX AC nodes is shifted in phase relative to the RX coil current I_{RL}, the amplitude I_{M} of the RX coil current I_{RL} also changes. Since the phase of the voltage V_{AC21_RX} does not always operate in phase with the RX coil current I_{RL}, a portion of the rectified current I_{RECT} supplied to the main LDO circuit 40 does not contribute to V_{RECT}, but leaks. This may be reflected in the amplitude I_{M} of the RX coil current I_{RL}, as shown in Equation 18.

$$[ Equation 18 ]$$

$$( \frac{1}{π} ) {\int }_{- θ}^{π - θ} {I}_{R L} d ω t = ( \frac{1}{π} ) {\int }_{- θ}^{π - θ} {I}_{M} sin ( ωt ) d ω t = {I}_{{REST}_{DC}}$$

$${I}_{M} = ( \frac{π}{2} ) \times ( \frac{1}{cos θ} ) {I}_{RECT \_ DC}$$

Based on Equations 17 and 18, an inductive rectified impedance Z_{RLeq} caused by phase-shift active reactance control may be obtained as shown in Equation 19.

$$[ Equation 19 ]$$

$${Z}_{R L e q} = \frac{{V}_{AC {21}_{R X}} ( ω )}{{I}_{R L} ( ω )} ≅ \frac{( \frac{4}{π} ) {V}_{R E C T} \times {e}^{j θ}}{( \frac{π}{2} ) ( \frac{1}{cos θ} ) {I}_{RECT \_ DC}} = ( \frac{8}{{π}^{2}} ) {R}_{L} \times cos θ ( cos θ + j sin θ )$$

Referring to Equation 19, it can be seen that the inductive rectified impedance Z_{RLeq} includes a reactive component (i.e., a complex number) in both the numerator and denominator, similar to inductance.

The rectified voltage V_{RECT} may be obtained as shown in Equation 20, using the reflected power V_{P_REFL} and the dividing ratio of each impedance, and the coil current I_{RL} can be obtained by dividing the reflected power V_{P_REFL} by the total impedance, as shown in Equation 21.

$$[ Equation 20 ]$$

$${V}_{RECT} ≅ \frac{π}{4} {V}_{P \_ REFL} ( \frac{{Z}_{R L e q}}{{Z}_{P \_ REFL} + {Z}_{S} + {Z}_{RLeq}} ) = \frac{π}{4} {V}_{P \_ REFL} ( \frac{{A}_{R L} ( \frac{8}{{π}^{2}} ) {R}_{L} \times cos θ ( cos θ + j sin θ )}{( {R}_{R X} + {A}_{R L} ( \frac{8}{{π}^{2}} ) {{R}_{L} ( cos θ )}^{2} ) + j ( {X}_{R X} + {A}_{R L} ( \frac{8}{{π}^{2}} ) {R}_{L} cos θ sin θ )} )$$

$$[ Equation 21 ]$$

$${I}_{R L} = \frac{π}{4} {V}_{P \_ REFL} ( \frac{1}{( {R}_{R X} + {A}_{R L} ( \frac{8}{{π}^{2}} ) {{R}_{L} ( cos θ )}^{2} ) + j ( {X}_{R X} + {A}_{R L} ( \frac{8}{{π}^{2}} ) {R}_{L} cos θ sin θ )} )$$

The magnitudes of the rectified voltage V_{RECT} and the RX coil current I_{RL} under quasi-reactive rectification, i.e., |V_{RECT}| and |I_{RL}|, may be calculated as shown in Equations 22 and 23.

$$[ Equation 22 ]$$

$$\vert {V}_{RECT} \vert = \frac{π}{4} {V}_{P \_ REFL} ( \frac{{A}_{R L} ( \frac{8}{{π}^{2}} ) {R}_{L} ( cos θ )}{{( {R}_{R X} + {A}_{R L} ( \frac{8}{{π}^{2}} ) {{R}_{L} ( cos θ )}^{2} )}^{2} + {( {X}_{R X} + {A}_{R L} ( \frac{8}{{π}^{2}} ) {R}_{L} cos θ sin θ )}^{2}} )$$

$$[ Equation 23 ]$$

$$\vert {I}_{RL} \vert = \frac{π}{4} {V}_{P \_ REFL} ( \frac{1}{{( {R}_{R X} + {A}_{R L} ( \frac{8}{{π}^{2}} ) {{R}_{L} ( cos θ )}^{2} )}^{2} + {( {X}_{R X} + {A}_{R L} ( \frac{8}{{π}^{2}} ) {R}_{L} cos θ sin θ )}^{2}} )$$

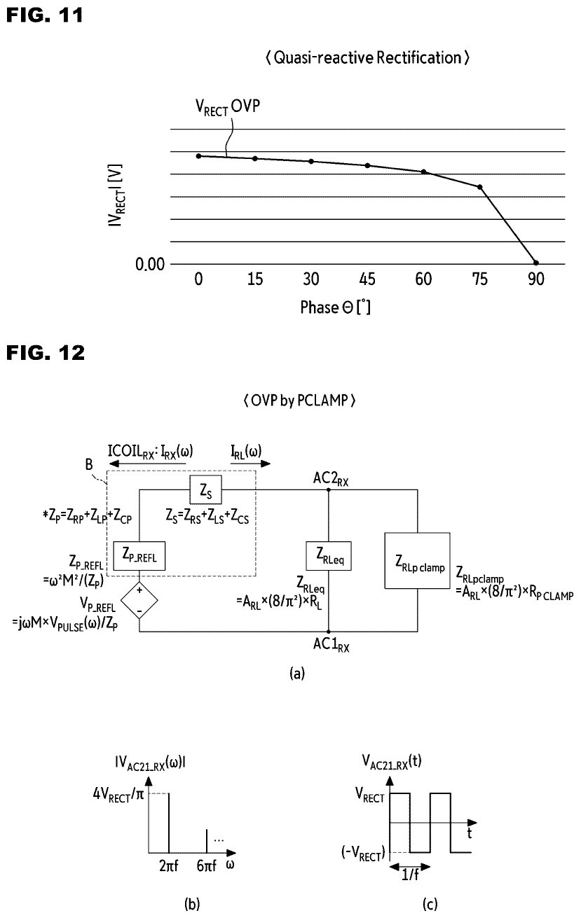

FIG. 11 is a phase-voltage graph for explaining the clamping effect on the rectified voltage in a wireless power charging system using quasi-reactive rectification according to some embodiments.

Referring to Equations 12 and 13 above, in the resistive rectification method, only the real parts of both the rectified voltage V_{RECT} and the coil current I_{RL} are considered. That is, the phases of the rectified voltage V_{RECT} and the coil current I_{RL} are the same.

On the other hand, referring to Equations 20 and 21 above, the quasi-reactive rectification method adds cosine and sine terms due to phase shift, resulting in imaginary (j) components in addition to real components.

Referring to FIG. 11, compared to the rectified voltage V_{RECT} at 0° phase, the greater the amount of phase shift, the smaller the rectified load impedance Z_{RLeq} becomes due to the cosine terms in Equation 19, and the lower the magnitude of the rectified voltage V_{RECT} becomes.

Using this principle, the quasi-reactive rectification method may control the rectified voltage V_{RECT} through clamping.

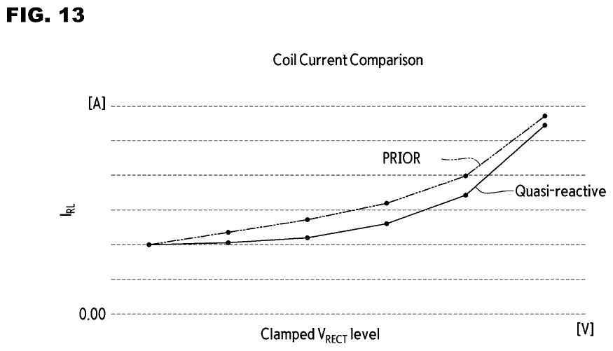

(a) of FIG. 12 illustrates an RX-side power transmission model of a comparative example using a clamp resistor. FIG. 13 is a graph comparing coil current increases against clamped voltage levels between the comparative example of FIG. 12 and the present disclosure.

Referring to (a)-(c) of FIG. 12, the comparative RX-side power transmission model has a clamp resistor R_{PCLAMP} added in parallel between the first and second RX AC nodes, compared to the RX-side power transmission model in FIG. 6.

An impedance Z_{RLpclamp} of the clamp resistor R_{PCLAMP} appears in parallel with the rectified load impedance Z_{RLeq} between the first and second RX AC nodes, and may be expressed as shown in Equation 24.

$${\underline{Z}}_{\underline{RLpclamp}} = {A}_{R L} ( \frac{8}{{π}^{2}} ) \times {R}_{PCLAMP} \qquad [ Equation 24 ]$$

In the comparative model, due to the clamp resistor R_{PCLAMP}, the impedance between the first and second RX AC nodes is reduced, which lowers the AC gain, thus clamping the rectified voltage V_{RECT}.

Referring to (a)-(c) of FIG. 12 and to FIG. 13, the coil current under overvoltage in the quasi-reactive rectification method (“Quasi-reactive”) of the present disclosure increases more slowly than that of the comparative example (“PRIOR”) as the clamped rectified voltage V_{RECT} increases. Therefore, for the same coil current, the clamping performance for the rectified voltage V_{RECT} during overvoltage is more favorable in the quasi-reactive rectification method of the present disclosure than in the comparative example.

Additionally, since no extra clamp resistor is used in the quasi-reactive rectification method, unnecessary power loss due to resistive elements does not occur.

FIG. 14 is a detailed block diagram of a rectified-gate-signal generator according to some embodiments. FIG. 15 is a block diagram of a gate signal generator in FIG. 14. The rectified-gate-signal generator 135 and the coil current sensor 120 in FIG. 3 may be implemented as a (rectified-gate)-signal generator 200 and a coil current sensor 210, respectively, in FIG. 14 according to some embodiments.

Referring to FIG. 14, the rectified-gate-signal generator 200 may be implemented to include a differentiator circuit 221, an integrator circuit 222, a plurality of zero-edge detector or zero-edge detector circuits 231, 232, and 233, a plurality of timing controllers 241, 242, and 243, and a (gate) signal generator 260.

In one embodiment, the zero-edge detectors 231, 232, and 233 may generate short pulse signals at the point where the signals of each path reach 0 V due to a rising edge or a falling edge. Rising-edge zero points and falling-edge zero points may alternatively be represented by other types of signals that can represent such zero-edge detection.

For example, the zero-edge detector 231 may detect rising-edge zero points RISING EDGE_DIFF and falling-edge zero points FALLING EDGE_DIFF of a differentiated signal d/dt(V_{ISEN}) of coil sensing information V_{ISEN}, output from the coil current sensor 210, output from the differentiator circuit 221. For example, the zero-edge detector 232 may detect rising-edge zero points RISING EDGE_NORM and falling-edge zero points FALLING EDGE_NORM of the coil sensing information V_{ISEN}, output from the coil current sensor 210. For example, the zero-edge detector 233 may detect rising-edge zero points RISING EDGE_INTEG and falling-edge zero points FALLING EDGE_INTEG of an integrated signal Integ(V_{ISEN}) of the coil sensing information V_{ISEN}, output from the integrator circuit 222. Note that the term “coil sensing information” may refer to the information itself, or its form of representation, such as voltage or current signals derived from the receiver coil that represent the receiver coil current, and/or signal(s) carrying or indicating such information, as context indicates.

In some embodiments, the timing controllers 241, 242, and 243 may delay the signals output from the zero-edge detectors 231, 232, and 233 by an amount corresponding to the selected rising time delay information SET_TRISE_MUXED, and output the delayed signals. Alternatively, the timing controllers 241, 242, and 243 may delay the signals output from the zero-edge detectors 231, 232, and 233 by an amount corresponding to the selected falling time delay information SET_TFALL_MUXED, and output the delayed signals.

Referring to FIG. 15, the gate signal generator 260 includes a first (gate) signal generator 260A and a second (gate) signal generator 260B.

The first gate signal generator 260A includes a third multiplexer 261 and a first gate signal generator 262. The second gate signal generator 260B includes a fourth multiplexer 263 and a second gate signal generator 264. When falling-edge delay signals FALLING EDGE_DIFF_DELAY, FALLING EDGE_NORM_DELAY, and FALLING EDGE_INTEG_DELAY and rising-edge delays RISING EDGE_DIFF_DELAY, RISING EDGE_NORM_DELAY, and RISING EDGE_INTEG_DELAY output from the zero-edge detectors 231, 232, and 233 are received, the third and fourth multiplexers 261 and 263 output falling-edge delay signals and rising-edge delay signals, selected according to the gate-signal control signal SET_GATE_SIG[1:0], as gate-on signals GATE_ON1 and GATE_ON3 and gate-off signals GATE_OFF2 and GATE_OFF4, respectively. The gate signal generator 262 generates first and fourth rectifier gate signals QG1_{PH} and QG4_{PH} based on the gate-on signal GATE_ON1 and the gate-off signal GATE_OFF2. The gate signal generator 264 generates second and third rectifier gate signals QG2_{PH} and QG3_{PH} based on the gate-on signal GATE_ON3 and the gate-off signal GATE_OFF4.

The configuration and operation of the rectified-gate-signal generator 200 of FIGS. 14 and 15 will be described later in further detail with reference to FIGS. 15 through 17.

FIG. 16 is a timing diagram for explaining an embodiment of the operation of the wireless power charging system of FIG. 1.

Referring to FIGS. 14, 15, and 16, the coil sensing information V_{ISEN} is converted into a differentiated signal d/dt(V_{ISEN}) through the differentiator 221. The differentiated signal d/dt(V_{ISEN}) is output as a rising-edge differentiated signal RISING EDGE_DIFF and a falling-edge differentiated signal FALLING EDGE_DIFF by the zero-edge detector 231.

The timing controller 241 delays the rising- and falling-edge differentiated signals RISING EDGE_DIFF and FALLING EDGE_DIFF by preset delay setting values SET_TRISE_MUXED and SET_TFALL_MUXED, to implement a phase difference between the differential signal (AC2_{RX}−AC1_{RX}) and the RX coil current I_{RL}, and outputs a rising-edge delay differentiated signal RISING EDGE_DIFF_DELAY and a falling-edge delay differentiated signal FALLING EDGE_DIFF_DELAY.

In the period from 0 to t1 when the overvoltage flag signal FLAG_{OVP} is low, the RX device 20 sets the delay between the rising-edge differentiated signal RISING EDGE_DIFF and the rising-edge delay differentiated signal RISING EDGE_DIFF_DELAY (e.g., during the t41-t51 period) to T_{RISE1}, and the delay between the falling-edge differentiated signal FALLING EDGE_DIFF and the falling-edge delay differentiated signal FALLING EDGE_DIFF_DELAY (e.g., during the t61-t71 and t62-t72 periods) to T_{FALL1}, such that the phase difference between the differential signal (AC2_{RX}−AC1_{RX}) and the RX coil current I_{RL} becomes zero (0°). The fourth multiplexer 263 selects the gate-on signal GATE_ON3 as the rising-edge delay differentiated signal RISING EDGE_DIFF_DELAY and the gate-off signal GATE_OFF4 as the falling-edge delay differentiated signal FALLING EDGE_DIFF_DELAY.

In some embodiments, the gate signal generator 264 outputs the second rectifier gate signal QG2_{P}H as high when the gate-on signal GATE_ON3 is high, and outputs the second rectifier gate signal QG2_{P}H as low when the gate-off signal GATE_OFF4 becomes high, thereby generating a toggling second rectifier gate signal QG2_{P}H. In this manner, in the first period up to t1, the differential signal (AC2_{RX}−AC1_{RX}) and the RX coil current I_{RL} operate with a phase difference of 0°.

The other rectifier gate signals, i.e., the first, third, and fourth rectifier gate signals QG1_{PH}, QG3_{PH}, and QG4_{PH}, may also be generated using the same operation scheme as the second rectifier gate signal QG2_{P}H. For example, the first rectifier gate signal QG1_{PH} may be generated in the same phase as the fourth rectifier gate signal QG4_{PH}, and the second rectifier gate signal QG2_{P}H may be generated in the same phase as the third rectifier gate signal QG3_{PH}.

In the period from t1 to t3 when the overvoltage flag signal FLAG_{OVP} is high, the timing controller 241 changes the delay between the rising-edge differentiated signal RISING EDGE_DIFF and the rising-edge delay differentiated signal RISING EDGE_DIFF_DELAY (e.g., during the t43-t53 period) from T_{RISE1} to T_{RISE2}, according to the first multiplexer 141. At this time, since T_{RISE2} is applied to a period that follows the rising edge of the second rectifier gate signal QG2_{P}H at t21, the timing controller 241 changes the delay between the falling-edge differentiated signal FALLING EDGE_DIFF and the falling-edge delay differentiated signal FALLING EDGE_DIFF_DELAY (e.g., during the t64-t74 period) from T_{FALL1} to T_{FALL2} according to the second multiplexer 142. In this case, the gate-on/gate-off timing of the second rectifier gate signal QG2_{P}H is changed, such that the differential signal (AC2_{RX}−AC1_{RX}) lags in phase by a certain amount of degrees (θ°) relative to the RX coil current I_{RL}, thereby enabling a voltage clamping operation for the rectified voltage V_{RECT} as a quasi-reactive rectification operation. When a differential signal is used, the probability of a change in the operating point, even with a small phase delay, without maintaining periodic operation during the delay time is minimized, the likelihood of an error relative to the expected phase-shift operation is reduced.

When the voltage clamping operation lowers the level of the rectified voltage V_{RECT} to reach a preset overvoltage falling level OVP_F (e.g., at t3), the overvoltage flag signal FLAG_{OVP} transitions to a low level, and the delay between the rising-edge differentiated signal RISING EDGE_DIFF and the rising-edge delay differentiated signal RISING EDGE_DIFF_DELAY (e.g., during the t44-t54 period) is restored from T_{RISE2} to T_{RISE1}. Likewise, the delay between the falling-edge differentiated signal FALLING EDGE_DIFF and the falling-edge delay differentiated signal FALLING EDGE_DIFF_DELAY (e.g., during the t65-t75 period) is restored from T_{FALL2} to T_{FALL1}. As a result, the phase difference between the differential signal (AC2_{RX}−AC1_{RX}) and the RX coil current I_{RL} is restored to 0°, thereby terminating the voltage clamping operation and enabling a normal rectification operation.

In some embodiments, the delay settings T_{RISE1} and T_{RISE2}, and T_{FALL1} and T_{FALL2} may be applied identically to all of the first, second, third, and fourth rectifier gate signals QG1_{PH}, QG2_{PH}, QG3_{PH}, and QG4_{PH}. Alternatively, in some embodiments, as long as the differential signal (AC2_{RX}−AC1_{RX}) operates with a phase shift of θ° with respect to the RX coil current I_{RL}, the delay settings T_{RISE1} and T_{RISE2}, and T_{FALL1} and T_{FALL2} may be applied differently to each of the first, second, third, and fourth rectifier gate signals QG1_{PH}, QG2_{PH}, QG3_{PH}, and QG4_{PH}.

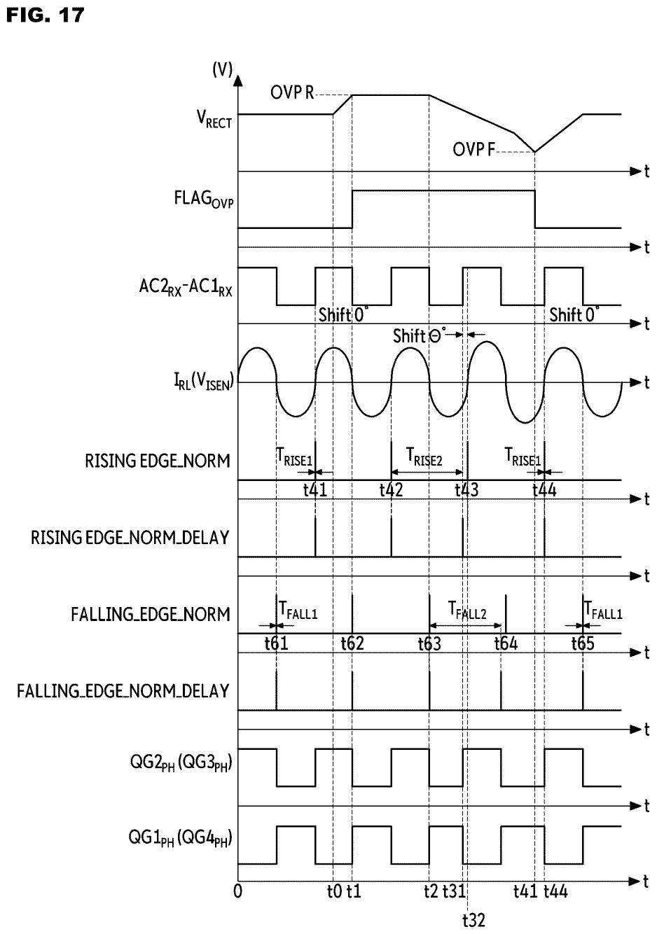

FIG. 17 is a timing diagram for explaining another embodiment of the operation of the wireless power charging system of FIG. 1. The timing diagram of FIG. 17 will hereinafter be described with reference further to the path without the differentiator 221 and the integrator 222 of FIG. 13.

Referring to FIGS. 14, 15, and 17, first, in the period from t0 to t1, the zero-edge detector 232 of the RX device 20 outputs the RX coil current I_{RL} sensed from the RX LC tank circuit 21 as a rising-edge normal signal RISING EDGE_NORM and a falling-edge normal signal FALLING EDGE_NORM.

The timing controller 242 delays the rising-edge normal signal RISING EDGE_NORM and the falling-edge normal signal FALLING EDGE_NORM by the preset delay setting values SET_TRISE_MUXED and SET_TFALL_MUXED to implement a phase difference between the differential signal (AC2_{RX}−AC1_{RX}) and the RX coil current I_{RL}, and outputs a rising-edge delay normal signal RISING EDGE_NORM_DELAY and a falling-edge delay normal signal FALLING EDGE_NORM_DELAY.

In the period from 0 to t1, when the overvoltage flag signal FLAG_{OVP} is low, the RX device 20 sets the delay between the rising-edge normal signal RISING EDGE_NORM and the rising-edge delay normal signal RISING EDGE_NORM_DELAY (e.g., at t41) to T_{RISE1}, and the delay between the falling-edge normal signal FALLING EDGE_NORM and the falling-edge delay normal signal FALLING EDGE_NORM_DELAY (e.g., at t61) to T_{FALL1}, such that the phase difference between the differential signal (AC2_{RX}−AC1_{RX}) and the RX coil current I_{RL} becomes approximately or substantially 0°. In this case, T_{RISE1} and T_{FALL1} may be zero. The fourth multiplexer 263 selects the gate-on signal GATE_ON3 as the rising-edge delay normal signal RISING EDGE_NORM_DELAY and the gate-off signal GATE_OFF4 as the falling-edge delay normal signal FALLING EDGE_NORM_DELAY.

In some embodiments, the gate signal generator 264 outputs the second rectifier gate signal QG2_{PH} as high when the gate-on signal GATE_ON3 is high, and outputs the second rectifier gate signal QG2_{PH} as low when the gate-off signal GATE_OFF4 becomes high, thereby generating a toggling rectifier gate signal QG2_{PH}. In this manner, when the second rectifier gate signal QG2_{PH} is generated, the differential signal (AC2_{RX}−AC1_{RX}) and the RX coil current I_{RL} operate with a phase difference close to 0° in the first period up to t1. At this time, when using the zero-point edges of the coil sensing information (V_{ISEN} and I_{ISEN}), T_{RISE1} and T_{FALL1} become very small.

The other rectifier gate signals, i.e., the first, third, and fourth rectifier gate signals QG1_{PH}, QG3_{PH}, and QG4_{PH} may also be generated using the same operation scheme as the second rectifier gate signal QG2_{PH}. For example, the first rectifier gate signal QG1_{PH} may be generated in the same phase as the fourth rectifier gate signal QG4_{PH}, and the second rectifier gate signal QG2_{P}H may be generated in the same phase as the third rectifier gate signal QG3_{PH}.

In the period from t1 to t3, when the overvoltage flag signal FLAG_{OVP} is high, the timing controller 242 delays a rising-edge normal delay signal RISING EDGE_NORM_DELAY to t43 instead of t42 according to the first multiplexer 141, thereby changing the delay of the rising-edge normal delay signal RISING EDGE_NORM_DELAY relative to the rising-edge normal signal RISING EDGE_NORM to T_{RISE2} (e.g., during the t42-t43 period). Similarly, the timing controller 242 delays a falling-edge normal delay signal FALLING EDGE_NORM_DELAY to t64 instead of t63 according to the second multiplexer 142, thereby changing the delay of the falling-edge normal delay signal FALLING EDGE_NORM_DELAY relative to the falling-edge normal signal FALLING EDGE_NORM from T_{FALL1} to T_{FALL2} (e.g., during the t63-t64 period). At this time, as can be seen in FIG. 17, T_{RISE2} and T_{FALL2} have a long delay corresponding to approximately (360°−θ°)×period because, based on the zero points of the RX coil current I_{RL}, the differential signal (AC2_{RX}−AC1_{RX}) cannot be immediately shifted (or advanced) in phase by θ°. Thus, instead of directly performing a θ° phase lead, the falling-edge normal delay signal FALLING EDGE_NORM_DELAY may be delayed in phase by a (360°−θ°) phase lag in consideration of a subsequent periodic operation, thereby achieving an effect equivalent to a phase lead.

In this case, the gate-on/gate-off timing of the second rectifier gate signal QG2_{P}H is changed, such that the differential signal (AC2_{RX}−AC1_{RX}) is shifted (or lags) in phase by θ° relative to the RX coil current I_{RL}, thereby enabling a voltage clamping operation according to a quasi-reactive rectification operation.

When the voltage clamping operation causes the rectified voltage V_{RECT} to fall to the preset overvoltage falling level OVP_F (e.g., at t41), the delay between the rising-edge normal signal RISING EDGE_NORM and the rising-edge normal delay signal RISING EDGE_NORM_DELAY is restored from T_{RISE2} to T_{RISE1} (e.g., at t44), and the delay between the falling-edge normal signal FALLING EDGE_NORM and the falling-edge normal delay signal FALLING EDGE_NORM_DELAY is restored from T_{FALL2} to T_{FALL1} (e.g., at t65). As a result, the phase difference between the differential signal (AC2_{RX}−AC1_{RX}) and the RX coil current I_{RL} is restored to 0°, thereby terminating the voltage clamping operation and enabling a normal rectification operation.

In some embodiments, the delay settings T_{RISE1} and T_{RISE2}, and T_{FALL1} and T_{FALL2} may be applied identically to the first, second, third, and fourth rectifier gate signals QG1_{PH}, QG2_{PH}, QG3_{PH}, and QG4_{PH}. Alternatively, in some embodiments, as long as the differential signal (AC2_{RX}−AC1_{RX}) operates with a phase lag of θ° with respect to the RX coil current I_{RL}, the delay settings T_{RISE1} and T_{RISE2}, and T_{FALL1} and T_{FALL2} may be applied differently to each of the first, second, third, and fourth rectifier gate signals QG1_{PH}, QG2_{PH}, QG3_{PH}, and QG4_{PH}.

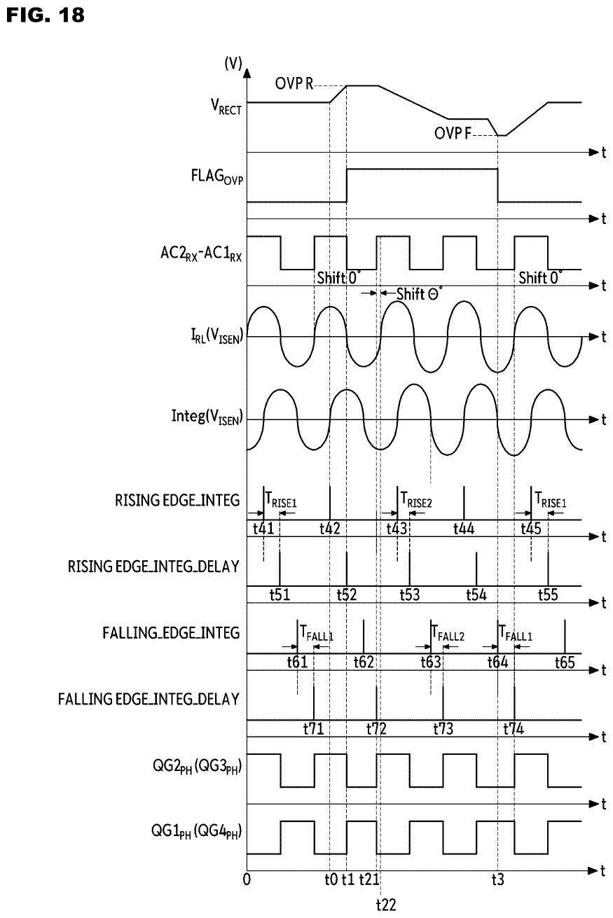

FIG. 18 is a timing diagram for explaining another embodiment of the operation of the wireless power charging system of FIG. 1.

Referring to FIGS. 14, 15, and 18, first, the coil sensing information (V_{ISEN} and I_{ISEN}) is converted into an integrated signal Integ(V_{ISEN}) through the integrator 222. The integrated signal Integ(V_{ISEN}) is output from the zero-edge detector 233 as a rising-edge integrated signal RISING EDGE_INTEG and a falling-edge integrated signal FALLING EDGE_INTEG.

The timing controller 243 delays the rising- and falling-edge integrated signals RISING EDGE_INTEG and FALLING EDGE_INTEG by the preset delay setting values SET_TRISE_MUXED and SET_TFALL_MUXED to implement a phase difference between the differential signal (AC2_{RX}−AC1_{RX}) and the RX coil current I_{RL}, and outputs a rising-edge delay integrated signal RISING EDGE_INTEG_DELAY and a falling-edge delay integrated signal FALLING EDGE_INTEG_DELAY.

In the period from 0 to t1, when the overvoltage flag signal FLAG_{OVP} is low, the RX device 20 sets the delay between the rising-edge integrated signal RISING EDGE_INTEG and the rising-edge delay integrated signal RISING EDGE_INTEG_DELAY (e.g., during the t41-t51 period) to T_{RISE1}, and the delay between the falling-edge integrated signal FALLING EDGE_INTEG and the falling-edge delay integrated signal FALLING EDGE_INTEG_DELAY (e.g., during the t61-t71 period) to T_{FALL1}, such that the phase difference between the differential signal (AC2_{RX}−AC1_{RX}) and the RX coil current I_{RL} becomes 0°. The fourth multiplexer 263 selects the gate-on signal GATE_ON3 as the falling-edge delay integrated signal FALLING EDGE_INTEG_DELAY and the gate-off signal GATE_OFF4 as the rising-edge delay integrated signal RISING EDGE_INTEG_DELAY.

In some embodiments, the gate signal generator 264 outputs the second rectifier gate signal QG2_{PH} as high when the gate-on signal GATE_ON3 is high, and outputs the second rectifier gate signal QG2_{PH} as low when the gate-off signal GATE_OFF4 becomes high, thereby generating a toggling rectifier gate signal QG2_{PH}. In this manner, when the second rectifier gate signal QG2_{PH} is generated, the differential signal (AC2_{RX}−AC1_{RX}) and the RX coil current I_{RL} operate with a phase difference of 0° in the first period up to t1 (“SHIFT 0°”).

The other rectifier gate signals, i.e., the first, third, and fourth rectifier gate signals QG1_{PH}, QG3_{PH}, and QG4_{PH} may also be generated using the same operation scheme as the second rectifier gate signal QG2_{PH}. For example, the first rectified gate signal QG1_{PH} may be generated in the same phase as the fourth rectifier gate signal QG4_{PH}, and the second rectifier gate signal QG2_{PH} may be generated in the same phase as the third rectifier gate signal QG3_{PH}.

In the period from t1 to t3, when the overvoltage flag signal FLAG_{OVP} is high, the timing controller 243 changes the delay between the rising-edge integrated signal RISING EDGE_INTEG and the rising-edge delay integrated signal RISING EDGE_INTEG_DELAY (e.g., during the t43-t53 period) from T_{RISE1} to T_{RISE2} according to the first multiplexer 141. Also, the timing controller 243 changes the delay between the falling-edge integrated signal FALLING EDGE_INTEG and the falling-edge delay integrated signal FALLING EDGE_INTEG_DELAY (e.g., during the t63-t73 period) from T_{FALL1} to T_{FALL2} according to the second multiplexer 142. In this case, the gate-on/gate-off timing of the second rectifier gate signal QG2_{PH} is changed, such that the phase of the differential signal (AC2_{RX}−AC1_{RX}) is shifted by θ° relative to the RX coil current I_{RL}, thereby enabling a voltage clamping operation for the rectified voltage V_{RECT} as a quasi-reactive rectification operation. In this embodiment, the gate-on signal GATE_ON3 is selected as the falling-edge delayed integration signal FALLING EDGE_INTEG_DELAY, and the gate-off signal GATE_OFF4 is selected as the rising-edge delayed integration signal RISING EDGE_INTEG_DELAY, thereby achieving a phase-shift operation with minimum delays T_{RISE2} and T_{FALL2}.

When the voltage clamping operation lowers the level of the rectified voltage V_{RECT} to reach the preset overvoltage falling level OVP_F (e.g., at t3), the delay between the rising-edge integration signal RISING EDGE_INTEG and the rising-edge delayed integration signal RISING EDGE_INTEG_DELAY is restored from T_{RISE2} to T_{RISE1} (e.g., after the t45-t55 period). In addition, the delay between the falling-edge integration signal FALLING EDGE_INTEG and the falling-edge delayed integration signal FALLING EDGE_INTEG_DELAY is restored from T_{FALL2} to T_{FALL1} (e.g., after the t64-t74 section). As a result, the phase difference between the differential signal (AC2_{RX}−AC1_{RX}) and the RX coil current I_{RL} is restored to 0°, thereby terminating the voltage clamping operation and enabling a normal rectification operation.

In some embodiments, the delay settings T_{RISE1} and T_{RISE2}, and T_{FALL1} and T_{FALL2} may be applied identically to the first, second, third, and fourth rectifier gate signals QG1_{PH}, QG2_{PH}, QG3_{PH}, and QG4_{PH}. Alternatively, in some embodiments, as long as the differential signal (AC2_{RX}−AC1_{RX}) operates with a phase lag of θ° relative to the RX coil current I_{RL}, the delay settings T_{RISE1} and T_{RISE2}, and T_{FALL1} and T_{FALL2} may be applied differently to each of the first, second, third, and fourth rectifier gate signals QG1_{PH}, QG2_{PH}, QG3_{PH}, and QG4_{PH}.

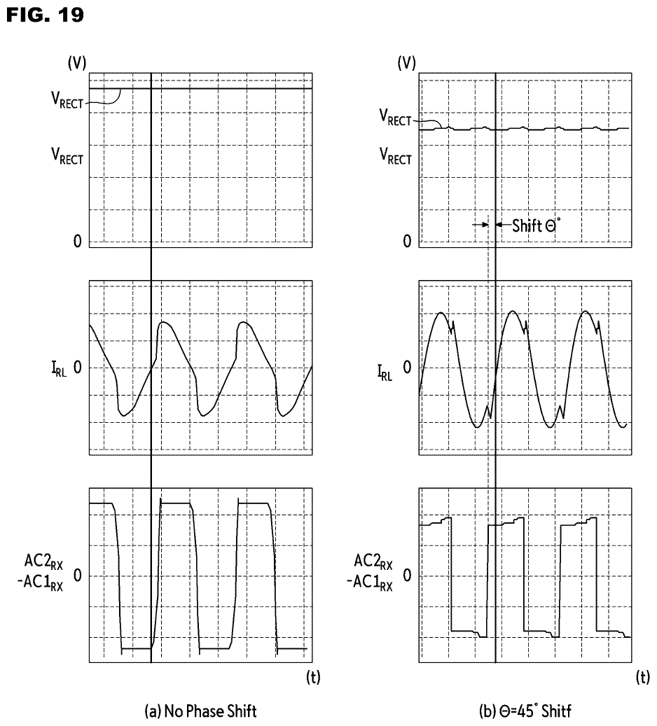

FIG. 19 presents graphs showing a rectified voltage, RX AC voltages, and a coil current according to the operation of a wireless power charging system according to some embodiments, in an overvoltage state.

Referring to FIG. 19(b), which corresponds to a case where phase shift is performed, it can be seen that the differential signal (AC2_{RX}−AC1_{RX}) is shifted forward by 45°, compared to FIG. 19(a), which corresponds to a case where no phase shift is performed based on the zero-crossing points of the RX coil current I_{RL}. The rectified voltage V_{RECT} is at a lower level when a 45° phase lead shift occurs, as shown in FIG. 19(b), than when no phase shift is performed, as shown in FIG. 19(a), due to a voltage clamping operation.

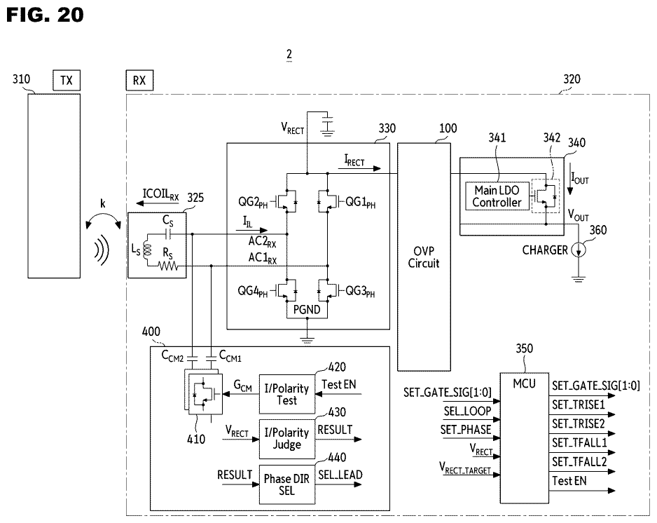

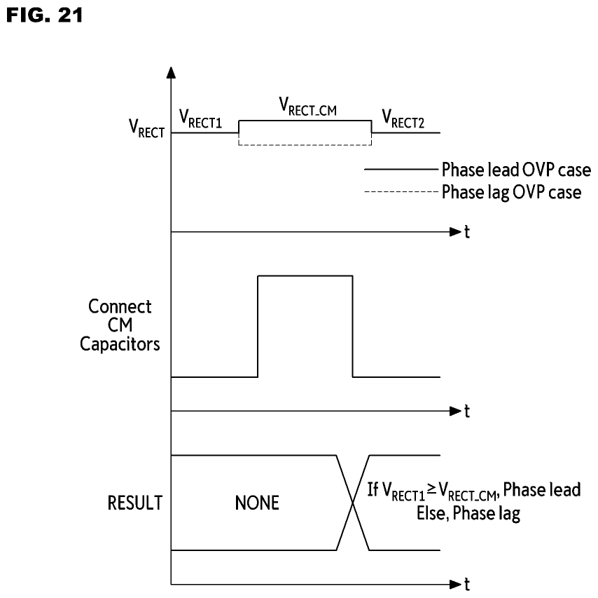

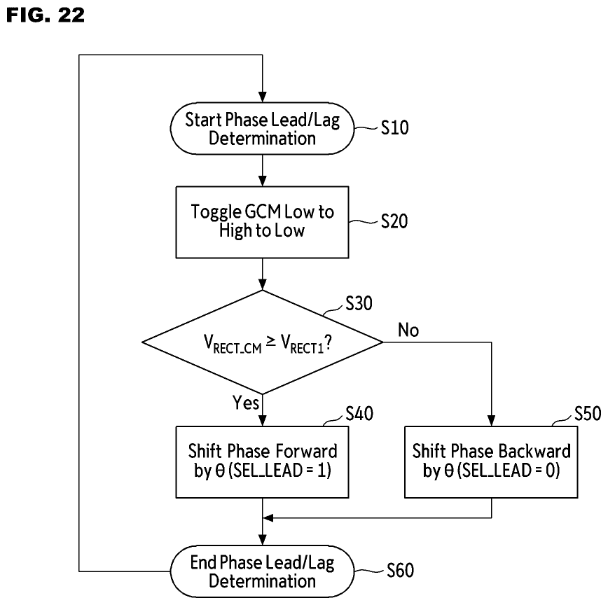

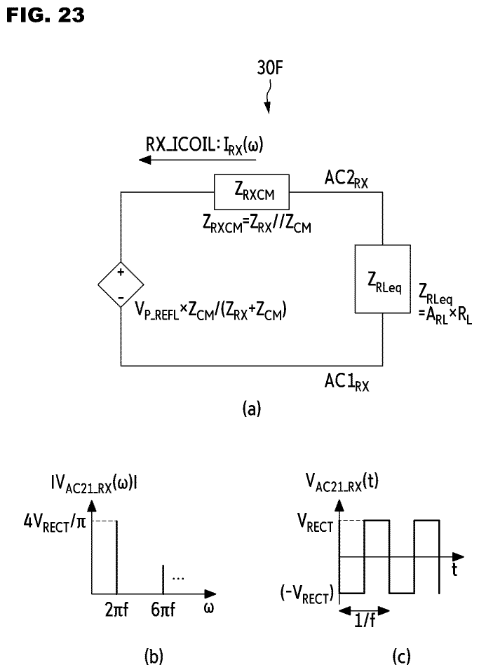

FIG. 20 is a block diagram illustrating a wireless power charging system according to some embodiments of the present disclosure. FIG. 21 is a time-voltage graph for explaining how to determine the direction of a phase shift in the wireless power charging system of FIG. 20. FIG. 22 is a flowchart for explaining an operating method of the wireless power charging system of FIG. 20. FIG. 23 illustrates an RX-side power transmission model for explaining how to determine the polarity of a reactance component X_{RX} in the wireless power charging system of FIG. 20.

Referring to FIGS. 20 through 23, an RX device 320 includes a phase-direction determination circuit 400, an RX LC tank circuit 325, a rectifier circuit 330, a main LDO circuit 340, an RX MCU 350, an OVP circuit 100, and a battery 360. The RX LC tank circuit 325, rectifier circuit 330, main LDO circuit 340, RX MCU 350, OVP circuit 100, and battery 360 correspond to their respective counterparts in FIG. 1, and thus redundant description thereof will be omitted. For example, the receiver LC tank circuit 325 is configured to receive wireless charging power from transmitter device 310.

The phase-direction determination circuit 400 performs a test for determining the direction of a phase shift. The phase-direction determination circuit 400 includes a pass transistor circuit 410 (which can include a first pass transistor and a second pass transistor), an imaginary part polarity tester circuit 420, an imaginary part polarity determiner circuit 430, and a phase direction selector circuit 440. In some embodiments, the phase-direction determination circuit 400 includes a first communication capacitor C_{CM1} connected in series to a first AC node where a first RX AC voltage AC1_{RX} is generated, a second communication capacitor C_{CM2} connected in series to a second AC node where a second RX AC voltage AC2_{RX} is generated, the first pass transistor connected between a second end of the first communication capacitor C_{CM1} and a ground node with a polarity test signal G_{CM} connected to its gate, and the second pass transistor connected between a second end of the second communication capacitor C_{CM2} and the ground node with the polarity test signal G_{CM} connected to its gate. The first and second pass transistors may or may not (e.g., selectively) connect the first and second communication capacitors C_{CM1} and C_{CM2} to the ground node according to a gate signal. When the communication capacitances C_{CM1} and C_{CM2} are connected to the output of the RX LC tank circuit 325, they operate as a combined capacitance together with an RX load capacitor C_{S}. Thus, a rectified voltage V_{RECT} may vary depending on whether the first and second communication capacitances C_{CM1} and C_{CM2} are connected.

When a determination is needed in advance as to whether to perform a quasi-reactive rectification operation through a phase lead or phase lag under a non-overvoltage condition, the RX MCU 50 activates a test enable signal TEST_EN (and outputs the test enable signal TEST_EN to the phase-direction determination circuit 400) and determines the direction of a phase shift (S10).

To this end, the imaginary part polarity tester circuit 420 outputs a polarity test signal GCM that toggles from low to high to low to the pass transistor circuit 410 according to the test enable signal TEST_EN. When the polarity test signal GCM is high, the pass transistor circuit 410 connects the first and second CM paths CM1 NET and CM2 NET to the ground node, thereby connecting the first communication capacitor C_{CM1} between the AC1_{RX} node and the ground node and the second communication capacitor C_{CM2} between the AC2_{RX} node and the ground node. When the polarity test signal GCM is low, the pass transistor circuit 410 disconnects the first and second CM paths CM1 NET and CM2 NET from the ground node, thereby disconnecting the first and second communication capacitors C_{CM1} and C_{CM2} from the ground node.

The imaginary part polarity determiner circuit 430 compares the current level of the rectified voltage V_{RECT} that varies according to the operation of the pass transistor circuit 410 in response to the polarity test signal GCM, with the previous level of the rectified voltage V_{RECT}. For example, the imaginary part polarity determiner circuit 430 determines whether a rectified voltage level V_{RECT_CM} when the polarity test signal GCM is high is higher or lower than a rectified voltage level V_{RECT1} when the polarity test signal GCM is low, and outputs the result of the determination as a result signal RESULT (S30).

The phase direction selector circuit 440 determines the direction of a phase shift to be performed based on the result signal RESULT (S40 and S50). If the rectified voltage level V_{RECT_CM} is higher than the rectified voltage level V_{RECT1} (“Yes” in S30), the phase direction selector 440 determines a phase lead to be performed (S40). If the rectified voltage level V_{RECT_CM} is lower than the rectified voltage level V_{RECT1} (“No” in S30), the phase direction selector 440 determines a phase lag to be performed (S50).

The phase direction selector circuit 440 outputs the result of the determination in step S40 or S50, i.e., a determination signal SEL_LEAD, to the RX MCU 350 (S60).

The RX MCU 50 sets timing delay information according to the determination signal SEL_LEAD. For example, when SEL_LEAD=1, the RX MCU 50 sets second-type timing delay information (SET_T_{RISE2}, SET_T_{FALL2}) with a second setting value as phase lead values. When SEL_LEAD=0, the RX MCU 50 sets the second-type timing delay information (SET_T_{RISE2}, SET_T_{FALL2}) with the second setting value to phase lag values.

Referring to FIG. 23, based on an impedance Z_{CM} by the phase-direction determination unit 400 in the frequency domain, the rectified voltage V_{RECT} may be expressed as indicated by Equation 25.

$$[ Equation 25 ]$$

$$( \frac{4}{π} + … ) {V}_{R E C T} = {V}_{P \_ REFL} \times \frac{{Z}_{C M}}{{Z}_{R X} + {Z}_{C M}} \times \frac{{Z}_{R L e q}}{{Z}_{R L e q} + {Z}_{R X C M}} = {V}_{P \_ REFL} \times \frac{{Z}_{R L e q}}{{Z}_{R X} + ( 1 + \frac{{Z}_{R X}}{{Z}_{C M}} ) {Z}_{R L e q}}$$

When a resistive impedance Z_{RX} of the phase-direction determination unit 400 is expressed as Z_{RX}=R_{RX}+jX_{RX}=|Z_{RX}|e^{jθ}^{_{RX}}, a phase θ_{RX} of the resistive impedance Z_{RX} becomes negative if a reactance X_{RX} is negative. By applying Euler's formula, Equation 25 may be rearranged into Equation 26.

$$[ Equation 26 ]$$

$$( \frac{4}{π} + … ) {V}_{R E C T} = {V}_{P \_ REFL} \times \frac{{Z}_{R L e q}}{{Z}_{R X} + ( 1 + \vert \frac{{Z}_{R X}}{{Z}_{C M}} \vert ( - sin ( {θ}_{R X} ) + j cos ( {θ}_{R X} ) ) ) {Z}_{R L e q}}$$

According to Equation 26, when the reactance X_{RX} is negative, making the phase θ_{RX} negative, the rectified voltage V_{RECT} decreases. Additionally, when the reactance X_{RX} is positive, making the phase θ_{RX} positive, the rectified voltage V_{RECT} increases. Thus, the phase-direction determination circuit 400 may determine the reactance X_{RX} to be negative when the rectified voltage V_{RECT} decreases, and to be positive when the rectified voltage V_{RECT} increases.

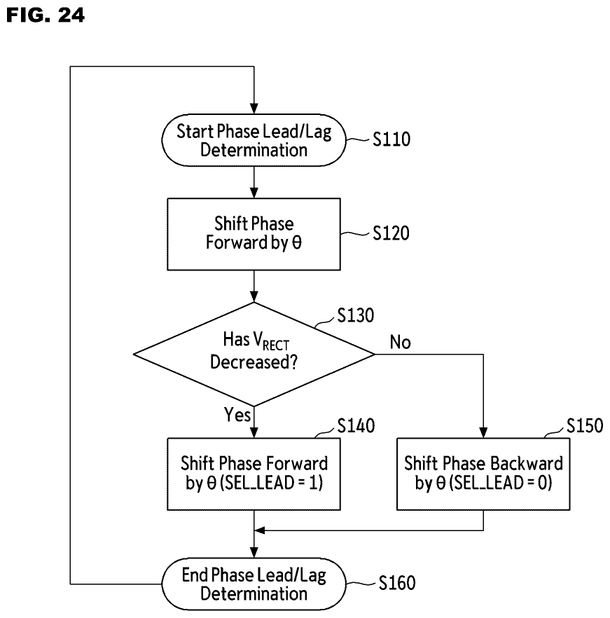

FIG. 24 is a flowchart illustrating an operating method of a wireless power charging system according to some embodiments of the present disclosure. Unlike the embodiment of FIG. 22, the embodiment of FIG. 24 may determine the direction of a phase shift without using the phase-direction determination circuit 400.

When a determination is needed in advance as to whether to perform a quasi-reactive rectification operation through a phase lead or phase lag under a non-overvoltage condition, the RX MCU 50 activates the test enable signal TEST_EN and determines the direction of a phase shift (S110). For a test, a phase lead is performed first for a predetermined period (S120). Then, if the rectified voltage V_{RECT} decreases (“Yes” in S130), the RX MCU sets the determination signal SEL_LEAD to 1 to perform a phase lead upon the occurrence of an overvoltage (S140) and terminates the test (S160). If the rectified voltage V_{RECT} increases after the phase lead performed in S120 (“No” in S130), the RX MCU sets the determination signal SEL_LEAD to 0 to perform a phase lag upon the occurrence of an overvoltage (S150) and terminates the test (S160).

Although the embodiments of the present invention have been described above with reference to the accompanying drawings, the present invention is not limited to the above embodiments, and may be fabricated in various different forms. Those skilled in the art will appreciate that the present invention may be embodied in other specific forms without changing the technical spirit or essential features of the present invention. Accordingly, the above-described embodiments should be understood in all respects as illustrative and not restrictive.

What is claimed is:

1. A receiver device comprising:
a receiver LC tank circuit including a receiver load capacitor and a receiver coil and configured to receive wireless charging power from a transmitter device;
a rectifier circuit configured to rectify receiver AC voltages of a differential signal provided from the receiver LC tank circuit into a rectified voltage in response to rectifier gate signals; and
an overvoltage protection circuit configured to generate and output to the rectifier circuit the rectifier gate signals,
wherein the overvoltage protection circuit is configured to generate the rectifier gate signals so as to cause a shift a phase of the differential signal between the receiver AC voltages relative to a receiver coil current in the receiver coil, in response to the rectified voltage reaching or exceeding an overvoltage rising threshold.

2. The receiver device of claim 1, further comprising:
a receiver microcontroller unit (MCU) configured to output a gate-signal control signal, first-type timing delay information, and second-type timing delay information to the overvoltage protection circuit based on the rectified voltage,
wherein the overvoltage protection circuit is configured to generate the rectifier gate signals based on the gate-signal control signal, the first-type timing delay information, and/or the second-type timing delay information.

3. The receiver device of claim 2, wherein the receiver MCU is configured to:
obtain a first setting value corresponding to a preset phase setting;
generate the second-type timing delay information based on the phase setting signal; and
output the second-type timing delay information to the overvoltage protection circuit so that the overvoltage protection circuit adjusts the phase of the differential signal between the receiver AC voltages relative to the receiver coil current based on the second-type timing delay information.

4. The receiver device of claim 2, wherein the receiver MCU is configured to:
obtain a second setting value;
generate the second-type timing delay information indicating the second setting value; and
output the second-type timing delay information to the overvoltage protection circuit so that the overvoltage protection circuit adjusts the phase of the differential signal between the receiver AC voltages relative to the receiver coil current based on the second setting value of the second-type timing delay information,
wherein the receiver MCU is configured to continually adjust the second setting value until the rectified voltage reaches a target rectified voltage.

5. The receiver device of claim 1, wherein the overvoltage protection circuit includes:
a comparator configured to compare the rectified voltage with the overvoltage rising threshold and output an overvoltage flag signal;
a coil current sensor configured to sense the receiver coil current in the receiver coil and thereby output coil sensing information; and
a controller configured to generate and output the rectifier gate signals to the rectifier circuit based on the overvoltage flag signal and the coil sensing information.

6. The receiver device of claim 5, wherein the controller includes:
a first multiplexer configured to select and output either first rising time delay information or second rising time delay information as selected rising time delay information based on the overvoltage flag signal;
a second multiplexer configured to select and output either first falling time delay information or second falling time delay information as selected falling time delay information based on the overvoltage flag signal; and
a rectified-gate-signal generator configured to generate and output the rectifier gate signals corresponding to the selected rising time delay information and the selected falling time delay information to the rectifier circuit.

7. The receiver device of claim 6, wherein the rectified-gate-signal generator is further configured to:
generate a rising-edge delay signal by shifting rising-edge zero points of a differentiated signal of the coil sensing information by the selected rising time delay information;
generate a falling-edge delay signal by shifting falling-edge zero points of the differentiated signal by the selected falling time delay information; and
generate the rectifier gate signals based on the rising-edge delay signal and the falling-edge delay signal and output the rectifier gate signals to the rectifier circuit.

8. The receiver device of claim 6, wherein the rectified-gate-signal generator is further configured to:
generate a rising-edge delay signal by shifting rising-edge zero points of an integrated signal of the coil sensing information by the selected rising time delay information;
generate a falling-edge delay signal by shifting falling-edge zero points of the integrated signal by the selected falling time delay information; and
generate the rectifier gate signals based on the rising-edge delay signal and the falling-edge delay signal and output the rectifier gate signals to the rectifier circuit.

9. The receiver device of claim 1, further comprising:
a phase-direction determination circuit configured to perform a test for determining a phase shift direction,
wherein the phase-direction determination circuit is configured to:
connect or disconnect communication capacitors between AC nodes and a ground node according to a toggling polarity test signal;
compare a first level of the rectified voltage in response of connecting the communication capacitors and a second level of the rectified voltage in response of disconnecting the communication capacitors; and
determine the phase shift direction based on a result of the comparison,
wherein the overvoltage protection circuit is configured to generate the rectifier gate signals to shift the phase of the differential signal relative to the receiver coil current in accordance with the phase shift direction.

10. The receiver device of claim 1, wherein the overvoltage protection circuit is further configured to:
phase shift the differential signal between the receiver AC voltages in a first direction relative to the receiver coil current according to a test enable signal;
continue to phase shift the differential signal between the receiver AC voltages in the first direction in response to the rectified voltage becoming lower after than before the phase shift; and
phase shift the differential signal between the receiver AC voltages in a second direction, which is different from the first direction, in response to the rectified voltage becoming higher after the phase shift in the first direction.

11. A method of operating a receiver device that wirelessly receives power from a transmitter device, the method comprising:
comparing a rectified voltage of the receiver device with an overvoltage rising threshold;
generating coil sensing information by sensing a receiver coil current induced from the transmitter device through a receiver coil;
obtaining a rising-edge zero points signal indicating rising-edge zero points of the coil sensing information and a falling-edge zero points signal indicating falling-edge zero points of the coil sensing information;
shifting the indicated rising-edge zero points and falling-edge zero points in a first direction relative to zero points in the current by applying a first delay to the rising-edge zero points and the falling-edge zero points signals, the first direction corresponding to a phase lag or phase lead;
generating rectifier gate signals, for a rectifier circuit, based on the delayed rising-edge zero points and the falling-edge zero points signals; and
adjusting the rectified voltage by adjusting a phase difference between a differential signal between receiver AC voltages and the receiver coil current by applying the rectifier gate signals to the rectifier circuit.

12. The method of claim 11, wherein the shifting comprises:
continuing the shifting in the first direction in response to a voltage level of the rectified voltage being lower in comparison to the voltage level of the rectified voltage prior to a start of the shifting; and
shifting the indicated rising-edge zero points and falling-edge zero points of the coil sensing information in a second direction, which is different from the first direction, by applying a second delay to the rising-edge zero points signal and the falling-edge zero points signal in response to the voltage level of the rectified voltage becoming higher in comparison to the voltage level of the rectified voltage after the start of the shifting.

13. The method of claim 11, wherein
the indicated rising-edge zero points of the coil sensing information are rising-edge zero points of a differentiated signal of the coil sensing information, and
the indicated falling-edge zero points of the coil sensing information are falling-edge zero points of the differentiated signal.

14. The method of claim 11, wherein
the indicated rising-edge zero points of the coil sensing information are rising-edge zero points of an integrated signal of the coil sensing information, and
the indicated falling-edge zero points of the coil sensing information are falling-edge zero points of the integrated signal.

15. A receiver device comprising:
a receiver LC tank circuit including a receiver load capacitor and a receiver coil;
a coil current sensor configured to generate coil sensing information by sensing a current induced from a transmitter device through the receiver coil;
a rectifier circuit including a plurality of switching transistors that are switched in response to rectifier gate signals, and configured to receive receiver AC voltages generated by the receiver LC tank circuit and rectify the receiver AC voltages into a rectified voltage;
an overvoltage protection circuit configured to generate the rectifier gate signals based on a comparison between an overvoltage reference level and the rectified voltage and to output the rectifier gate signals to the rectifier circuit; and
a main low-dropout (LDO) circuit configured to output a supply voltage with noise removed from the rectified voltage,
wherein the rectifier circuit is configured to adjust a phase difference between a differential signal between the receiver AC voltages and the receiver coil current based on the rectifier gate signals received from the overvoltage protection circuit.

16. The receiver device of claim 15, wherein the overvoltage protection circuit is further configured to generate the rectifier gate signals so as to cause the rectifier circuit to adjust the phase difference between the receiver coil current and the differential signal between the receiver AC voltages to lower the rectified voltage in response to the rectified voltage reaching the overvoltage reference level.

17. The receiver device of claim 16, further comprising:
a phase-direction determination circuit,
wherein the phase-direction determination circuit includes:
a first communication capacitor, a first end of the first communication capacitor is connected to a first AC node where a first receiver AC voltage is generated;
a second communication capacitor, a first end of the second communication capacitor is connected to a second AC node where a second receiver AC voltage is generated;
a first pass transistor connected between a second end of the first communication capacitor and a ground node, the first pass transistor configured to receive a polarity test signal at its gate; and
a second pass transistor connected between a second end of the second communication capacitor and the ground node and configured to receive the polarity test signal connected to its gate.

18. The receiver device of claim 17, wherein the phase-direction determination circuit is configured to:
compare a first rectified voltage level corresponding to an operation of the first and second pass transistors in response to the polarity test signal being at a first logic level with a second rectified voltage level corresponding to an operation of the first and second pass transistors in response to the polarity test signal being at a second logic level; and
determine a phase shift direction between the receiver coil current and the differential signal between the receiver AC voltages based on a result of the comparison between the first and second rectified voltage levels.

19. The receiver device of claim 15, wherein the overvoltage protection circuit includes:
a comparator configured to compare the overvoltage reference level with the rectified voltage and output an overvoltage flag signal;
a first multiplexer configured to select and output one of a plurality of pieces of first rising time delay information as selected rising time delay information based on the overvoltage flag signal;
a second multiplexer configured to select and output one of a plurality of pieces of first falling time delay information as selected falling time delay information based on the overvoltage flag signal; and
a controller configured to generate the rectifier gate signals based on the overvoltage flag signal, the coil sensing information, the selected rising time delay information, and the selected falling time delay information.

20. The receiver device of claim 19, wherein the controller includes:
a zero-edge detector circuit configured to detect zero points of a signal based on the coil sensing information;
a controller configured to generate a rising-edge delay signal and a falling-edge delay signal by shifting the detected zero points by the selected rising time delay information and the selected falling time delay information, respectively; and
a signal generator configured to generate the rectifier gate signals using the rising-edge delay signal and the falling-edge delay signal as gate-on or gate-off signals.
